(19) United States
(12) Patent Application Publication
(10) Pub. No.: US 2026/0267603 A1
(43) Pub. Date: Sep. 10, 2026

(54) SOUND EFFECT CONTROL METHOD AND ELECTRONIC DEVICE

(71) Applicant: HUAWEI TECHNOLOGIES CO., LTD., Shenzhen (CN)

(72) Inventors: Qi Luo, Shanghai (CN); Enbo Gao, Shanghai (CN); Jinkui Li, Shanghai (CN); Anxiang Zhang, Shanghai (CN)

(73) Assignee: HUAWEI TECHNOLOGIES CO., LTD., Shenzhen (CN)

(21) Appl. No.: 19/663,057

(22) Filed: Apr. 29, 2026

Related U.S. Application Data
(63) Continuation of application No. PCT/CN2025/070232, filed on Jan. 2, 2025.

(30) Foreign Application Priority Data
May 30, 2024 (CN) 202410700924.6

(51) Int. Cl. G06F 3/16; G06F 1/16; H04R 5/02; H04S 7/00

(52) U.S. Cl. CPC G06F 3/167; G06F 1/1641; G06F 1/1652; G06F 1/1677; H04R 5/02; H04S 7/30

(57) ABSTRACT

This application provides a method which includes: The electronic device plays in a first usage state, first audio through a first speaker and a second speaker by using a first sound effect, where the first speaker performs playing by using a first sound effect parameter, and the second speaker performs playing by using a second sound effect parameter; switches to a second usage state in response to a user operation; and plays the first audio through the first speaker and the second speaker by using a second sound effect, where the first speaker performs playing by using a third sound effect parameter, and the second speaker performs playing by using a fourth sound effect parameter. The first sound effect parameter is different from the third sound effect parameter, a deviation between the second sound effect and the first sound effect is less than a first threshold.

### CROSS-REFERENCE TO RELATED APPLICATIONS

This application is a continuation of International Application No. PCT/CN2025/070232, filed on Jan. 2, 2025, which claims priority to Chinese Patent Application No. 202410700924.6, filed on May 30, 2024, the disclosures of the aforementioned applications are hereby incorporated by reference in their entireties.

### TECHNICAL FIELD

This application relates to the field of terminal technologies, and in particular, to a sound effect control method and an electronic device.

### BACKGROUND

With development of terminal technologies, increasing users use foldable screen electronic devices. However, when the user uses the foldable screen electronic device, changing of a usage state of the foldable screen electronic device may be triggered. For example, the foldable screen electronic device is folded from an unfolded state into a stable folded state. In different usage states, a relative location of a speaker of the foldable screen electronic device is changed. Therefore, during changing of the usage state, sound effects corresponding to the different usage states may differ greatly, causing poor audio playing stability.

### SUMMARY

To resolve the foregoing technical problem, this application provides a sound effect control method and an electronic device. According to technical solutions provided in this application, audio played by the electronic device has similar sound effects in different usage states, to ensure sound effect stability of the electronic device and improve use experience of the user.

To achieve the foregoing technical objective, this application provides the following technical solutions.

According to a first aspect, a sound effect control method is provided, and is applied to an electronic device. The electronic device is a foldable screen electronic device, the electronic device includes a first speaker and a second speaker, and the first speaker and the second speaker are located in different display areas of a foldable screen of the electronic device. The method includes: The electronic device plays, in a first usage state, first audio through the first speaker and the second speaker by using a first sound effect, where the first speaker performs playing by using a first sound effect parameter, and the second speaker performs playing by using a second sound effect parameter. The electronic device switches to a second usage state in response to a user operation. The electronic device plays, in response to the electronic device switching to the second usage state, the first audio through the first speaker and the second speaker by using a second sound effect, where the first speaker performs playing by using a third sound effect parameter, the second speaker performs playing by using a fourth sound effect parameter, the first sound effect parameter is different from the third sound effect parameter, a deviation between the second sound effect and the first sound effect is less than a first threshold, and the first usage state and the second usage state are related to a folded state of the electronic device.

In this way, at least one speaker is indicated, in different usage states, to perform playing by using different sound effect parameters, so that the electronic device can still provide stable sound effect experience for a user during changing of a usage state, to avoid an unstable sound field and improve audio playing quality.

In addition, a sound effect output affects a service life of the speaker. Therefore, proper sound effect management can effectively reduce pressure and wear on hardware, to protect the speaker from being affected by excessive stress, and prolong the service life.

According to the first aspect, the electronic device is a trifold foldable screen electronic device, a first display area and a second display area of the foldable screen of the electronic device are connected by using a first folding shaft, the second display area and a third display area of the foldable screen of the electronic device are connected by using a second folding shaft, the first speaker is located in the first display area, and the second speaker is located in the third display area.

In one embodiment, the first speaker is located in an upper left corner of the first display area, and the second speaker is located in a lower right corner of the third display area; or the first speaker is located in a lower left corner of the first display area, and the second speaker is located in an upper right corner of the third display area.

That the speaker is located in the display area includes that the speaker is located in an internal location of the electronic device corresponding to the display area, and a speaker hole corresponding to the speaker may be located near the speaker. For example, the speaker hole corresponding to the first speaker is implemented, through hole digging or in another manner, on an upper side edge, a left side edge, a back side opposite to the foldable screen, and the foldable screen that correspond to the upper left corner of the first display area of the electronic device.

In this way, in a scenario in which a plurality of speakers configured in the electronic device are far away from each other, and consequently, sound effects are greatly affected by different usage states, the electronic device may adjust sound effect parameters of the speakers, so that sound effects generated through cooperation of the plurality of speakers can remain similar in different usage states of the electronic device, to improve use experience of the user.

In one embodiment, the first sound effect or the second sound effect is represented by a value of at least one of the following measurement parameters: loudness, sound pressure, a frequency, phase consistency, a stereo effect, and a distortion degree.

In one embodiment, that the deviation between the second sound effect and the first sound effect is less than the first threshold includes: A deviation between a first value of a measurement parameter corresponding to the first sound effect and a second value of a measurement parameter corresponding to the second sound effect is less than the first threshold.

In this way, the electronic device is debugged by measuring, by using a plurality of measurement parameters, whether sound effects provided by the electronic device in different usage states are similar. In this way, before the user actually uses the electronic device, the electronic device can be preconfigured with sound effect parameters corresponding to the different usage states, so that the sound effects of the electronic device are adaptively adjusted during subsequent use of the user.

In one embodiment, that the electronic device switches to the second usage state in response to the user operation includes: The electronic device obtains, in response to the user operation, first detection data reported by an acceleration sensor and/or a gyroscope sensor. The electronic device obtains the second usage state of the electronic device based on the first detection data.

In one embodiment, that the electronic device switches to the second usage state in response to the user operation includes: The electronic device learns, in response to the user operation, that the electronic device is in a power-on state or a reset state. The electronic device obtains second detection data reported by a magnetic sensor. The electronic device obtains the second usage state of the electronic device based on the second detection data.

In this way, the electronic device can obtain the usage state of the electronic device based on detection data reported by a sensor, to adaptively achieve a corresponding sound effect.

In one embodiment, that the electronic device plays the first audio through the first speaker and the second speaker by using the first sound effect includes: obtaining a first folding angle of the electronic device in response to a first audio event; determining the first usage state of the electronic device based on the first folding angle; and based on the first usage state, the first speaker performs playing by using the first sound effect parameter, and the second speaker performs playing by using the second sound effect parameter.

In this way, the electronic device can obtain the usage state of the electronic device based on the folding angle, to indicate the speaker to play audio by using a corresponding sound effect parameter.

In one embodiment, the second sound effect parameter is the same as the fourth sound effect parameter.

In this way, adaptive sound effect adjustment is implemented by adjusting a sound effect parameter of a single speaker. Adjusting the single sound effect parameter is easy, reducing difficulty in adjusting the sound effect.

In one embodiment, the second sound effect parameter is different from the fourth sound effect parameter.

In this way, adaptive sound effect adjustment is implemented by adjusting sound effect parameters of a plurality of speakers, providing better use experience for the user in more use scenarios. For example, the electronic device is placed on a fixed platform like a desktop. The electronic device may learn of, in response to changing of the usage state, one or more speakers in a display area on a side that is in contact with the fixed platform like the desktop, and implement sound effect adjustment by adjusting a sound effect parameter of the one or more speakers.

In one embodiment, the first usage state includes a stable state and a transition state, the stable state includes an unfolded state and a stable folded state, the unfolded state includes a state in which any two connected display areas of the foldable screen of the electronic device are fully unfolded, the stable folded state includes a state in which any two connected display areas of the foldable screen of the electronic device are fully unfolded or folded, and the transition state includes a state in which two connected display areas of the foldable screen of the electronic device are partially unfolded.

In one embodiment, the transition state includes a static transition state and a dynamic transition state, the static transition state indicates that duration in which the electronic device maintains the transition state is greater than or equal to a time threshold, and the dynamic transition state indicates that duration in which the electronic device maintains the transition state is less than the time threshold.

In this way, the electronic device may obtain the usage state of the electronic device based on a corresponding state between different display areas.

In one embodiment, the first usage state is a first stable state. That the electronic device plays, in the first usage state, the first audio through the first speaker and the second speaker by using the first sound effect includes: The electronic device matches, in a plurality of preconfigured sound effect parameters, the first sound effect parameter corresponding to the first stable state. The first speaker performs playing by using the first sound effect parameter.

In one embodiment, the first usage state is a first transition state. That the electronic device plays, in the first usage state, the first audio through the first speaker and the second speaker by using the first sound effect includes: The electronic device matches, in the plurality of preconfigured sound effect parameters, the first sound effect parameter corresponding to a second stable state, where the second stable state is a previous stable state adjacent to the first transition state. The first speaker performs playing by using the first sound effect parameter.

In this way, when being in a stable state, the electronic device can directly match a corresponding sound effect parameter. In addition, when being in a transition state, the electronic device may still maintain a sound effect parameter used in the previous stable state for subsequent use. In this way, regardless of any usage state, the electronic device can obtain the corresponding sound effect parameter, and implement subsequent adaptive adjustment of the sound effect based on the sound effect parameter through adaptive adjustment of the sound effect parameter.

In one embodiment, the first usage state is a first static transition state. That the electronic device plays, in the first usage state, the first audio through the first speaker and the second speaker by using the first sound effect includes: The electronic device matches, in the plurality of preconfigured sound effect parameters, a fifth sound effect parameter corresponding to a third stable state and a sixth sound effect parameter corresponding to a fourth stable state, where the third stable state and the fourth stable state are stable states adjacent to the first static transition state. The electronic device obtains the first sound effect parameter based on at least one of a second folding angle of the electronic device, the fifth sound effect parameter, and the sixth sound effect parameter. The first speaker performs playing by using the first sound effect parameter.

In one embodiment, the first usage state is a first dynamic transition state. That the electronic device plays, in the first usage state, the first audio through the first speaker and the second speaker by using the first sound effect includes: The electronic device matches, in the plurality of preconfigured sound effect parameters, a seventh sound effect parameter corresponding to a fifth stable state and an eighth sound effect parameter corresponding to a sixth stable state, where the fifth stable state and the sixth stable state are stable states adjacent to the first dynamic transition state. The electronic device obtains the first sound effect parameter based on at least one of a folding speed of the electronic device, a folding direction of the electronic device, the seventh sound effect parameter, and the eighth sound effect parameter. The first speaker performs playing by using the first sound effect parameter.

In this way, when being in a stable state, the electronic device can directly match a corresponding sound effect parameter. In addition, when the electronic device is in a transition state, the electronic device may further obtain, based on a sound effect parameter corresponding to an adjacent stable state, a sound effect parameter corresponding to the current transition state. In this way, regardless of any usage state, the electronic device can obtain the corresponding sound effect parameter, and implement subsequent adaptive adjustment of the sound effect based on the sound effect parameter through adaptive adjustment of the sound effect parameter.

In one embodiment, in a dynamic change process of folding the foldable screen of the electronic device, the first sound effect parameter is dynamically changed to the second sound effect parameter.

In this way, during changing of the usage state of the electronic device, the electronic device provides similar sound effect experience for the user as a sound effect parameter smoothly changes.

In one embodiment, after the electronic device plays, in response to the electronic device switching to the second usage state, the first audio through the first speaker and the second speaker by using the second sound effect, the method further includes: The electronic device displays a sound effect matching notification, where the sound effect matching notification indicates that the electronic device has currently matched a sound effect corresponding to the second usage state.

In this way, the electronic device may provide synchronized visual and auditory perception for the user in response to changing of the usage state, to improve use experience of the user.

According to a second aspect, an electronic device is provided. The electronic device is a foldable screen electronic device, and the electronic device includes a processor, a memory, a first speaker, and a second speaker. The first speaker and the second speaker are located in different display areas of a foldable screen of the electronic device, the memory, the first speaker, and the second speaker are coupled to the processor, and the memory is configured to store computer program code, where the computer program code includes computer instructions. When the processor reads the computer instructions from the memory, the electronic device is caused to perform the following operations: The electronic device plays, in a first usage state, first audio through the first speaker and the second speaker by using a first sound effect, where the first speaker performs playing by using the first sound effect parameter, and the second speaker performs playing by using a second sound effect parameter. The electronic device switches to a second usage state in response to a user operation. The electronic device plays, in response to the electronic device switching to the second usage state, the first audio through the first speaker and the second speaker by using a second sound effect, where the first speaker performs playing by using a third sound effect parameter, the second speaker performs playing by using a fourth sound effect parameter, the first sound effect parameter is different from the third sound effect parameter, a deviation between the second sound effect and the first sound effect is less than a first threshold, and the first usage state and the second usage state are related to a folded state of the electronic device.

According to the second aspect, the electronic device is a trifold foldable screen electronic device, a first display area and a second display area of the foldable screen of the electronic device are connected by using a first folding shaft, the second display area and a third display area of the foldable screen of the electronic device are connected by using a second folding shaft, the first speaker is located in the first display area, and the second speaker is located in the third display area.

In one embodiment, the first speaker is located in an upper left corner of the first display area, and the second speaker is located in a lower right corner of the third display area; or the first speaker is located in a lower left corner of the first display area, and the second speaker is located in an upper right corner of the third display area.

In one embodiment, the first sound effect or the second sound effect is represented by a value of at least one of the following measurement parameters: loudness, sound pressure, a frequency, phase consistency, a stereo effect, and a distortion degree.

In one embodiment, that the deviation between the second sound effect and the first sound effect is less than the first threshold includes: A deviation between a first value of a measurement parameter corresponding to the first sound effect and a second value of a measurement parameter corresponding to the second sound effect is less than the first threshold.

In one embodiment, that the electronic device plays the first audio through the first speaker and the second speaker by using the first sound effect includes: obtaining a first folding angle of the electronic device in response to a first audio event; determining the first usage state of the electronic device based on the first folding angle; and based on the first usage state, the first speaker performs playing by using the first sound effect parameter, and the second speaker performs playing by using the second sound effect parameter.

In one embodiment, that the electronic device switches to the second usage state in response to the user operation includes: The electronic device obtains, in response to the user operation, first detection data reported by an acceleration sensor and/or a gyroscope sensor. The electronic device obtains the second usage state of the electronic device based on the first detection data.

In one embodiment, that the electronic device switches to the second usage state in response to the user operation includes: The electronic device learns, in response to the user operation, that the electronic device is in a power-on state or a reset state. The electronic device obtains second detection data reported by a magnetic sensor. The electronic device obtains the second usage state of the electronic device based on the second detection data.

In one embodiment, the second sound effect parameter is the same as the fourth sound effect parameter.

In one embodiment, the second sound effect parameter is different from the fourth sound effect parameter.

In one embodiment, the first usage state is a first stable state. That the electronic device plays, in the first usage state, the first audio through the first speaker and the second speaker by using the first sound effect includes: The electronic device matches, in a plurality of preconfigured sound effect parameters, the first sound effect parameter corresponding to the first stable state. The first speaker performs playing by using the first sound effect parameter.

In one embodiment, the first usage state is a first transition state. That the electronic device plays, in the first usage state, the first audio through the first speaker and the second speaker by using the first sound effect includes: The electronic device matches, in the plurality of preconfigured sound effect parameters, the first sound effect parameter corresponding to a second stable state, where the second stable state is a previous stable state adjacent to the first transition state. The first speaker performs playing by using the first sound effect parameter.

In one embodiment, the first usage state is a first static transition state. That the electronic device plays, in the first usage state, the first audio through the first speaker and the second speaker by using the first sound effect includes: The electronic device matches, in the plurality of preconfigured sound effect parameters, a fifth sound effect parameter corresponding to a third stable state and a sixth sound effect parameter corresponding to a fourth stable state, where the third stable state and the fourth stable state are stable states adjacent to the first static transition state. The electronic device obtains the first sound effect parameter based on at least one of a second folding angle of the electronic device, the fifth sound effect parameter, and the sixth sound effect parameter. The first speaker performs playing by using the first sound effect parameter.

In one embodiment, the first usage state is a first dynamic transition state. That the electronic device plays, in the first usage state, the first audio through the first speaker and the second speaker by using the first sound effect includes: The electronic device matches, in the plurality of preconfigured sound effect parameters, a seventh sound effect parameter corresponding to a fifth stable state and an eighth sound effect parameter corresponding to a sixth stable state, where the fifth stable state and the sixth stable state are stable states adjacent to the first dynamic transition state. The electronic device obtains the first sound effect parameter based on at least one of a folding speed of the electronic device, a folding direction of the electronic device, the seventh sound effect parameter, and the eighth sound effect parameter. The first speaker performs playing by using the first sound effect parameter.

In one embodiment, in a dynamic change process of folding the foldable screen of the electronic device, the first sound effect parameter is dynamically changed to the second sound effect parameter.

In one embodiment, when the processor reads the computer instructions from the memory, the electronic device is further caused to perform the following operation: The electronic device displays a sound effect matching notification, where the sound effect matching notification indicates that the electronic device has currently matched a sound effect corresponding to the second usage state.

In one embodiment, the first usage state includes a stable state and a transition state, the stable state includes an unfolded state and a stable folded state, the unfolded state includes a state in which any two connected display areas of the foldable screen of the electronic device are fully unfolded, the stable folded state includes a state in which any two connected display areas of the foldable screen of the electronic device are fully unfolded or folded, and the transition state includes a state in which two connected display areas of the foldable screen of the electronic device are partially unfolded.

In one embodiment, the transition state includes a static transition state and a dynamic transition state, the static transition state indicates that duration in which the electronic device maintains the transition state is greater than or equal to a time threshold, and the dynamic transition state indicates that duration in which the electronic device maintains the transition state is less than the time threshold.

According to a third aspect, an electronic device is provided. The electronic device has a function of implementing the method according to any one of the first aspect and the possible implementations of the first aspect. The function may be implemented by hardware, or may be implemented by hardware executing corresponding software. The hardware or the software includes one or more modules corresponding to the function.

According to a fourth aspect, a computer-readable storage medium is provided. The computer-readable storage medium stores a computer program (which may also be referred to as instructions or code). When the computer program is executed by an electronic device, the electronic device is caused to perform the method according to any one of the first aspect or the implementations of the first aspect.

According to a fifth aspect, a computer program product is provided. When the computer program product runs on an electronic device, the electronic device is caused to perform the method according to any one of the first aspect or the implementations of the first aspect.

According to a sixth aspect, a circuit system is provided. The circuit system includes a processing circuit, and the processing circuit is configured to perform the method according to any one of the first aspect or the implementations of the first aspect.

According to a seventh aspect, a chip system is provided, and includes at least one processor and at least one interface circuit. The at least one interface circuit is configured to: perform a transceiver function, and send instructions to the at least one processor. When the at least one processor executes the instructions, the at least one processor performs the method according to any one of the first aspect or the implementations of the first aspect.

For technical effects of the foregoing aspects, refer to each other. Details are not described herein.

### BRIEF DESCRIPTION OF DRAWINGS

FIG. 1 is a diagram of a product form of a trifold foldable screen electronic device according to an embodiment of this application;

FIG. 2A is a diagram of a hardware structure of an electronic device according to an embodiment of this application;

FIG. 2B is a diagram of a quantity of magnetic sensors installed in an electronic device according to an embodiment of this application;

FIG. 3 is a block diagram of a software structure of an electronic device according to an embodiment of this application;

FIG. 4 is a diagram of a stable state according to an embodiment of this application;

FIG. 5 is a diagram of a transition state according to an embodiment of this application;

FIG. 6 is a schematic flowchart 1 of a sound effect control method according to an embodiment of this application;

FIG. 7 is a diagram of a program initialization procedure in a power-on or reset scenario according to an embodiment of this application;

FIG. 8 is a diagram of module interaction according to an embodiment of this application;

FIG. 9 is a schematic flowchart 2 of a sound effect control method according to an embodiment of this application;

FIG. 10 is a schematic flowchart 3 of a sound effect control method according to an embodiment of this application;

FIG. 11 is a schematic flowchart 4 of a sound effect control method according to an embodiment of this application;

FIG. 12 is a diagram of an interface according to an embodiment of this application;

FIG. 13 is a schematic flowchart 5 of a sound effect control method according to an embodiment of this application; and

FIG. 14 is a diagram of a structure of an electronic device according to an embodiment of this application.

### DESCRIPTION OF EMBODIMENTS

The following describes technical solutions in embodiments of this application with reference to accompanying drawings in embodiments of this application. In descriptions of embodiments of this application, terms used in the following embodiments are merely intended to describe specific embodiments, but not to limit this application. “One”, “a”, “the”, “the foregoing”, “this”, and “the one” of singular forms as used in this specification and the appended claims of this application are intended to include an expression form like “one or more”, unless clearly indicated to the contrary in the context. It should be further understood that, in the following embodiments of this application, “at least one” and “one or more” mean one or more (including two).

Reference to “one embodiment”, “some embodiments”, or the like described in this specification means that a specific feature, structure, or feature described with reference to the embodiment is included in one or more embodiments of this application. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. Terms “include”, “comprise”, “have”, and their variants all mean “include but are not limited to”, unless otherwise specifically emphasized in another manner. The term “connection” includes direct connection and indirect connection, unless otherwise specified. “First” and “second” are merely intended for description, and shall not be understood as an indication or implication of relative importance or an implicit indication of a quantity of indicated technical features.

In embodiments of this application, the word “example”, “for example”, or the like represents giving an example, an illustration, or a description. Any embodiment or design scheme described as an “example” or “for example” in embodiments of this application should not be construed as being more preferred or more advantageous than another embodiment or design scheme. Exactly, use of the word “example”, “for example”, or the like is intended to present a related concept in a specific manner.

In some embodiments, a foldable screen electronic device is configured with one or more speakers. During use of the foldable screen electronic device, a user may change a usage state of the foldable screen electronic device as required. In this case, because a relative location of the speaker of the foldable screen electronic device is changed in different usage states, sound effects corresponding to the different usage states may differ greatly, causing poor audio playing stability.

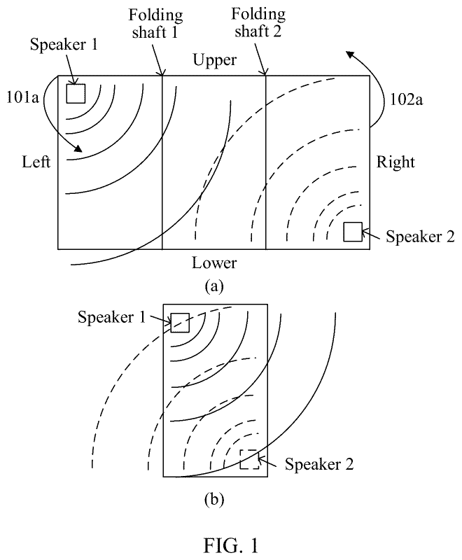

For example, FIG. 1 is a diagram of a product form of a trifold foldable screen electronic device according to an embodiment of this application. The trifold foldable screen electronic device is configured with a speaker 1 and a speaker 2. (a) in FIG. 1 is a form diagram of a trifold foldable screen electronic device that is fully unfolded. In this case, the trifold foldable screen electronic device is in a fully-unfolded state. The trifold foldable screen electronic device is configured with two folding shafts, and may be folded inwards in a direction 101a and outwards in a direction 102a along the folding shafts shown in (a) in FIG. 1. (b) in FIG. 1 is a form diagram of a trifold foldable screen electronic device that is fully folded. In this case, the trifold foldable screen electronic device is in a fully-folded state. In an example scenario, during audio playing, the trifold foldable screen electronic device starts to be folded or unfolded in response to a user operation. Due to changing of a physical structure, a sound field combination effect is changed after two speakers emit sound, and a sound field difference occurs in different usage states. For example, in some usage states, because sound fields of different speakers are not centralized, problems such as a blurry sound image and unclear human voice may occur.

In some embodiments, the electronic device can adjust a sound effect parameter based on a location relationship between the two speakers and ears of a user, to meet that the ears of the user receive a sound field that meets a stereo requirement. However, in a current solution, a sound effect can be ensured only when a location of a speaker is fixed. If relative locations of different speakers change because the electronic device triggers folding, sound effect stability in different usage states cannot be ensured.

In some embodiments, two display areas that are of a bifold foldable screen electronic device and that are located on both sides of a folding shaft are separately configured with one speaker. The bifold foldable screen electronic device can obtain a folding angle. When the folding angle is greater than or equal to a threshold, sound effect parameters of two speakers can be set, to provide a stereo field playing effect for the user. When the folding angle is less than the threshold, sound effect parameters of the two speakers can be set, to provide a non-stereo field playing effect for the user. In a current solution, sound effects change in different usage states by modifying the sound effect parameter of the speaker. However, sound effect stability in the different usage states cannot be ensured, and a use effect of the user is still affected.

In one embodiment, a sound effect control method provided in embodiments of this application may be applied to an electronic device 100. In one embodiment, the electronic device 100 may be, for example, a terminal device like a mobile phone, a tablet computer, an ultra-mobile personal computer (UMPC), a netbook, a personal digital assistant (PDA), a wearable device, or an artificial intelligence (AI) device. An operating system installed in the electronic device 100 includes but is not limited to Linux®, iOS®, Android®, Harmony®, Windows®, or another operating system. A specific type of the electronic device 100 and the installed operating system are not limited in this application.

In one embodiment, the electronic device 100 is configured with a flexible foldable screen, and the electronic device 100 may be folded or unfolded in response to a user operation.

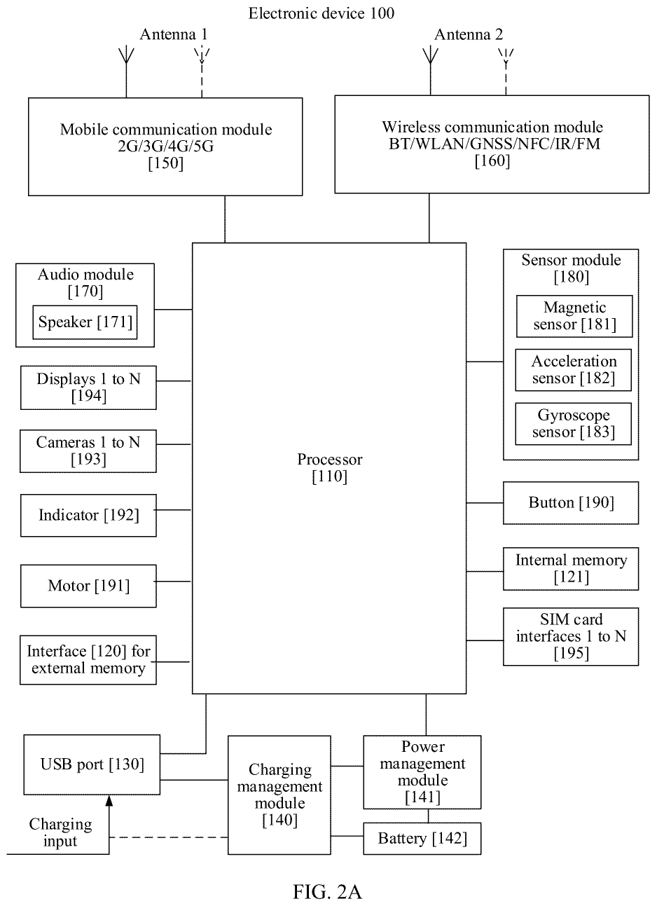

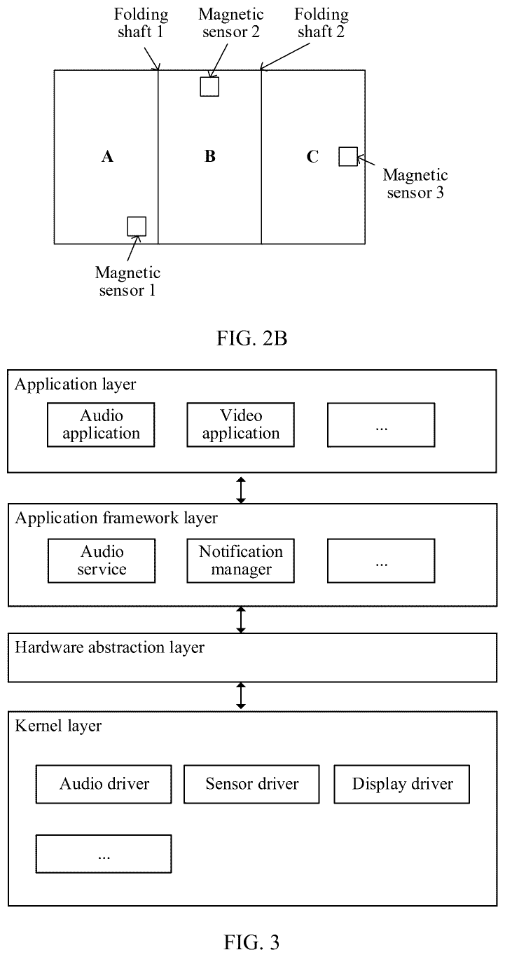

For example, FIG. 2A is a diagram of a structure of the electronic device 100.

The electronic device 100 may include a processor 110, an interface 120 for external memory, an internal memory 121, a universal serial bus (USB) interface 130, a charging management module 140, a power management module 141, a battery 142, an antenna 1, an antenna 2, a mobile communication module 150, a wireless communication module 160, an audio module 170, a sensor module 180, a button 190, a motor 191, an indicator 192, cameras 193, displays 194, and subscriber identity module (SIM) card interfaces 195.

It may be understood that the structure shown in this embodiment of this application does not constitute any specific limitation on the electronic device 100. In some other embodiments of this application, the electronic device 100 may include more or fewer components than those shown in the figure, combine some components, split some components, or have a different component arrangement. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, a neural network processing unit (NPU), and/or the like. Different processing units may be independent devices, or may be integrated into one or more processors.

The controller may generate an operation control signal based on an instruction operation code and a time sequence signal, to complete control of instruction reading and instruction execution.

A memory may be further disposed in the processor 110, and is configured to store instructions and data. In some embodiments, the memory in the processor 110 is a cache. The memory may store instructions or data just used or cyclically used by the processor 110. If needing to use the instructions or the data again, the processor 110 may directly invoke the instructions or the data from the memory. This avoids repeated access, reduces waiting time of the processor 110, and improves system efficiency.

In some embodiments, the processor 110 may include one or more interfaces. The interface may include an integrated circuit (I2C) interface, an inter-integrated circuit sound (I2S) interface, a pulse code modulation (PCM) interface, a universal asynchronous receiver/transmitter ( ) interface, a mobile industry processor interface (MIPI), a general-purpose input/output (GPIO) interface, a subscriber identity module (SIM) interface, a universal serial bus (USB) port, and/or the like.

The PCM interface may also be configured to perform audio communication, and sample, quantize, and code an analog signal. In some embodiments, the audio module 170 may be coupled to the wireless communication module 160 through a PCM bus interface. In some embodiments, the audio module 170 may also transfer an audio signal to the wireless communication module 160 through the PCM interface, to implement a function of answering a call through a Bluetooth headset. Both the I2S interface and the PCM interface may be configured to perform audio communication.

The MIPI interface may be configured to connect the processor 110 to a peripheral device like the display 194 or the camera 193. The MIPI interface includes a camera serial interface (CSI), a display serial interface (DSI), and the like. In some embodiments, the processor 110 communicates with the camera 193 through the CSI interface, to implement a photographing function of the electronic device 100. The processor 110 communicates with the display 194 through the DSI interface, to implement a display function of the electronic device 100.

It may be understood that an interface connection relationship between modules illustrated in this embodiment of this application is merely an illustrative description, and does not constitute any limitation on the structure of the electronic device 100. In some other embodiments of this application, the electronic device 100 may alternatively use an interface connection manner different from that in the foregoing embodiment, or use a combination of a plurality of interface connection manners.

The sensor module 180 may include a magnetic sensor 181, an acceleration sensor 182, a gyroscope sensor 183, a pressure sensor, a barometric pressure sensor, a distance sensor, an optical proximity sensor, a fingerprint sensor, a temperature sensor, a touch sensor, an ambient light sensor, a bone conduction sensor, and the like.

The magnetic sensor 181 includes a Hall sensor. The electronic device 100 may detect a usage state of the electronic device 100 by using the magnetic sensor 181. In some embodiments, the electronic device 100 obtains a current folding angle of the electronic device 100 based on detection data reported by the magnetic sensor 181, to obtain the usage state of the electronic device 100.

For example, when the electronic device 100 is a foldable screen electronic device, a foldable screen of the electronic device 100 may be divided into a plurality of display areas based on a folding shaft. At least one magnetic sensor is correspondingly configured in different display areas. For example, as shown in FIG. 2B, the electronic device 100 is a trifold foldable screen electronic device, and includes a folding shaft 1 and a folding shaft 2. A foldable screen of the electronic device 100 includes a display area A, a display area B, and a display area C. The display area A is configured with a corresponding magnetic sensor 1, the display area B is configured with a corresponding magnetic sensor 2, and the display area C is configured with a corresponding magnetic sensor 3. In this way, the electronic device 100 determines, based on detection data of the magnetic sensor 1 and the magnetic sensor 2, an unfolded/folded state between the display area A and the display area B (which may also be described as a usage state corresponding to the folding shaft 1), and determines, based on detection data of the magnetic sensor 2 and the magnetic sensor 3, an unfolded/folded state between the display area B and the display area C (which may also be described as a usage state corresponding to the folding shaft 2).

The acceleration sensor 182 may detect accelerations in various directions (usually on three axes) of the electronic device 100. When the electronic device 100 is still, a magnitude and a direction of gravity may be detected. The acceleration sensor 180E may be further configured to identify a posture of the electronic device, and is used in an application such as switching between a landscape mode and a portrait mode or a pedometer.

The gyroscope sensor 183 may be configured to determine a moving posture of the electronic device 100. In some embodiments, an angular velocity of the electronic device 100 around three axes (namely, axes x, y, and z) may be determined through the gyroscope sensor 183.

In some embodiments, the electronic device 100 obtains a current folding angle of the electronic device 100 based on detection data reported by the acceleration sensor 182 and the gyroscope sensor 183, to obtain the usage state of the electronic device 100.

The internal memory 121 may be configured to store computer-executable program code. The executable program code includes instructions. The internal memory 121 may include a program storage area and a data storage area. The program storage area may store an operating system, an application required by at least one function (for example, a voice playing function or an image playing function), and the like. The data storage area may store data (such as audio data and an address book) created during use of the electronic device 100, and the like. In addition, the internal memory 121 may include a high-speed random access memory, or may include a non-volatile memory, for example, at least one magnetic disk storage device, a flash storage device, or a universal flash storage (UFS). The processor 110 runs instructions stored in the internal memory 121 and/or instructions stored in the memory disposed in the processor, to perform various function applications and data processing of the electronic device 100.

The audio module 170 is configured to convert digital audio information into an analog audio signal for output, and is also configured to convert analog audio input into a digital audio signal. The audio module 170 may be further configured to encode and decode an audio signal. In some embodiments, the audio module 170 may be disposed in the processor 110, or a part of a functional module in the audio module 170 is disposed in the processor 110. The electronic device 100 may perform music playing, recording, or the like through the audio module 170. The audio module 170 may include a speaker 171, a receiver, a microphone, a headset jack, an application processor, and the like, to implement an audio function.

The speaker 171, also referred to as a “loudspeaker”, is configured to convert an electrical audio signal into a sound signal. The electronic device 100 may listen to music or answer a call in a hands-free mode through the speaker 171.

In some embodiments, the electronic device 100 is configured with at least one audio playing unit, and the audio playing unit is, for example, the speaker 171. In some examples, the electronic device 100 adjusts an audio playing effect by adjusting a sound effect parameter of the speaker 171. In one embodiment, the sound effect parameter includes, for example, loudness and a frequency.

In some examples, the electronic device 100 includes a plurality of speakers. For example, the electronic device 100 includes a first speaker and a second speaker, or the electronic device 100 includes more speakers.

In one embodiment, different speakers of the electronic device are located in different display areas of the foldable screen (for example, the display 194) of the electronic device.

For example, as shown in (a) in FIG. 1, the electronic device 100 is the trifold foldable screen electronic device, and the electronic device 100 includes two folding shafts, for example, the folding shaft 1 and the folding shaft 2. A first display area and a second display area of the foldable screen of the electronic device 100 are connected by using the folding shaft 1, and the second display area and a third display area of the foldable screen of the electronic device 100 are connected by using the folding shaft 2. The electronic device 100 includes at least two speakers, for example, the speaker 1 and the speaker 2. The speaker 1 is located in the first display area, and the speaker 2 is located in the third display area.

In one embodiment, as shown in (a) in FIG. 1, the speaker 1 is located in an upper left corner of the first display area, and the speaker 2 is located in a lower right corner of the third display area. Alternatively, the speaker 1 may be located in a lower left corner of the first display area, and the speaker 2 may be located in an upper right corner of the third display area.

That the speaker is located in the display area includes that the speaker is located in an internal location of the electronic device corresponding to the display area, and a speaker hole corresponding to the speaker may be located near the speaker. For example, in the scenario shown in (a) in FIG. 1, a speaker hole corresponding to the speaker 1 is implemented, through hole digging or in another manner, on an upper side edge, a left side edge, a back side opposite to the foldable screen, and the foldable screen that correspond to the upper left corner of the first display area of the electronic device 100.

In this way, in a scenario in which the plurality of speakers configured in the electronic device 100 are far away from each other, and consequently, sound effects are greatly affected by different usage states, the electronic device 100 may adjust sound effect parameters of the speakers, so that the sound effects generated through cooperation of the plurality of speakers can remain similar in the different usage states of the electronic device 100, to improve use experience of the user.

In some embodiments, the electronic device 100 plays, in a first usage state, first audio through the first speaker and the second speaker by using a first sound effect, where the first speaker performs playing by using a first sound effect parameter, and the second speaker performs playing by using a second sound effect parameter. The electronic device 100 switches to a second usage state in response to a user operation. The electronic device 100 plays, in response to the electronic device 100 switching to the second usage state, the first audio through the first speaker and the second speaker by using a second sound effect, where the first speaker performs playing by using a third sound effect parameter, the second speaker performs playing by using a fourth sound effect parameter, the first sound effect parameter is different from the third sound effect parameter, and a deviation between the second sound effect and the first sound effect is less than a first threshold.

In one embodiment, as described above, the electronic device 100 may obtain the usage state of the electronic device 100 based on detection data reported by a sensor 180 (for example, at least one of the magnetic sensor 181, the acceleration sensor 182, and the gyroscope sensor 183).

In one embodiment, the electronic device 100 may obtain the sound effect parameter of the speaker based on the usage state. In this way, the speaker plays audio based on the sound effect parameter. Alternatively, during audio playing, the electronic device 100 may obtain, based on a changed usage state, a sound effect parameter corresponding to the changed usage state, and indicate the speaker to play the audio based on the sound effect parameter, to implement adaptive adjustment of the sound effect parameter.

In this way, the electronic device 100 can provide similar sound effect experience for the user in different usage states.

The electronic device 100 may implement the display function through the GPU, the display 194, the application processor, and the like. The GPU is a microprocessor for image processing, and is connected to the display 194 and the application processor. The GPU is configured to: perform mathematical and geometric computation, and render an image. The processor 110 may include one or more GPUs that execute program instructions to generate or change display information.

The display 194 is configured to display an image, a video, and the like. The display 194 includes a display panel. The display panel may be made of a liquid crystal display (LCD), for example, an organic light-emitting diode (OLED), an active-matrix organic light-emitting diode (AMOLED), a flexible light-emitting diode (FLED), a mini-LED, a micro-LED, a micro-OLED, or a quantum dot light-emitting diode (QLED). In some embodiments, the electronic device 100 may include one or N displays 194, where N is a positive integer greater than 1.

In some embodiments, after dynamically changing the sound effect, the electronic device 100 may display a sound effect matching notification through the display 194. The sound effect matching notification indicates that the electronic device 100 has currently matched a sound effect corresponding to the second usage state. In this way, the user can experience synchronized visual and auditory perception, thereby improving use experience of the user.

A software system of the electronic device 100 may use a layered architecture, an event-driven architecture, a microkernel architecture, a microservice architecture, or a cloud architecture. In embodiments of this application, an Android system with the layered architecture is used as an example to describe a software structure of the electronic device 100.

FIG. 3 is a block diagram of the software structure of the electronic device 100 according to this embodiment of this application.

In a layered architecture, software is divided into several layers, and each layer has a clear role and task. The layers communicate with each other through a software interface. In some embodiments, an Android system is divided into four layers: an application layer, an application framework layer, a hardware abstraction layer (hardware abstraction layer, HAL) layer, and a kernel layer from top to bottom.

The application layer may include a series of application packages.

As shown in FIG. 3, the application package may include applications such as an audio application and a video application.

The application framework layer provides an application programming interface (API) and a programming framework for an application at the application layer. The application framework layer includes some predefined functions.

As shown in FIG. 3, the application framework layer may include an audio service, a notification manager, and the like.

The audio service is used to obtain, process, and perform transmission of audio data, and update an underlying channel of a corresponding scenario. In some examples, after a sound effect parameter is obtained, the audio service is used to process audio based on the sound effect parameter, to trigger, through an audio driver, a speaker (or another audio module) to play the processed audio, to achieve a required sound effect.

The notification manager is configured to: display and manage a notification. For example, after the sound effect is adjusted, the notification manager generates a notification, and displays the notification through a display driver, so that a user knows that the sound effect has been currently adjusted based on a usage state. The notification manager may further cause the application to display notification information in a status bar. The notification information may be used to convey a notification-type message, and may automatically disappear after a short pause, without user interaction. For example, the notification manager is configured to notify a sound effect adjustment, download completion, a message reminder, and the like. The notification manager may alternatively be a notification that appears in a top status bar of the system in a form of a graph or a scroll bar text, for example, a notification of an application that runs on a background, or may be a notification that appears on a screen in a form of a dialog window. For example, text information is prompted in the status bar, a prompt tone is given, the electronic device vibrates, or an indicator light blinks.

The HAL is an abstract interface of a device kernel driver, and provides a higher-level Java API framework with an application programming interface for accessing an underlying device. The HAL includes a plurality of library modules, and each library module implements an interface for a specific type of hardware component.

In some embodiments, after obtaining the usage state, the electronic device 100 determines, through the HAL, a sound effect parameter corresponding to the current usage state.

The kernel layer is a layer between hardware and software. The kernel layer includes, for example, the audio driver, a sensor driver, and the display driver.

The following describes in detail a sound effect control method provided in embodiments of this application by using an example in which an electronic device 100 is a trifold foldable screen electronic device, a configured audio playing unit is a speaker, and there are two speakers.

In some embodiments, a usage state of the electronic device is classified based on a use habit of a user. In one embodiment, the usage state of the electronic device may include a stable state and a transition state. The stable state may include an unfolded state and a stable folded state.

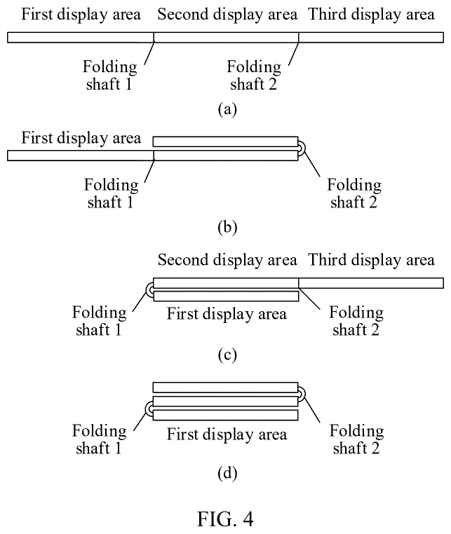

In embodiments of this application, as shown in FIG. 4, a display of a trifold foldable screen electronic device includes three display areas. A first display area and a second display area are connected by using a hinge of a folding shaft 1, and the second display area and a third display area are connected by using a hinge of a folding shaft 2. An unfolded state may include a state in which any two display areas connected by using a hinge are fully unfolded. For example, as shown in (a) in FIG. 4, the any two display areas connected by using the hinge are in the fully-unfolded state. In this case, the electronic device is currently in the unfolded state. A stable folded state may include a state in which any two display areas connected by using a hinge are fully unfolded or folded. For example, as shown in (b) in FIG. 4, the first display area and the second display area are in a fully-unfolded state, and the second display area and the third display area are in a fully-folded state. In this case, the electronic device is currently in the stable folded state. As shown in (c) in FIG. 4, the first display area and the second display area are in a fully-folded state, and the second display area and the third display area are in a fully-unfolded state. In this case, the electronic device is currently in the stable folded state. As shown in (d) in FIG. 4, any two display areas connected by using a hinge are in a fully-folded state. In this case, the electronic device is currently in the stable folded state.

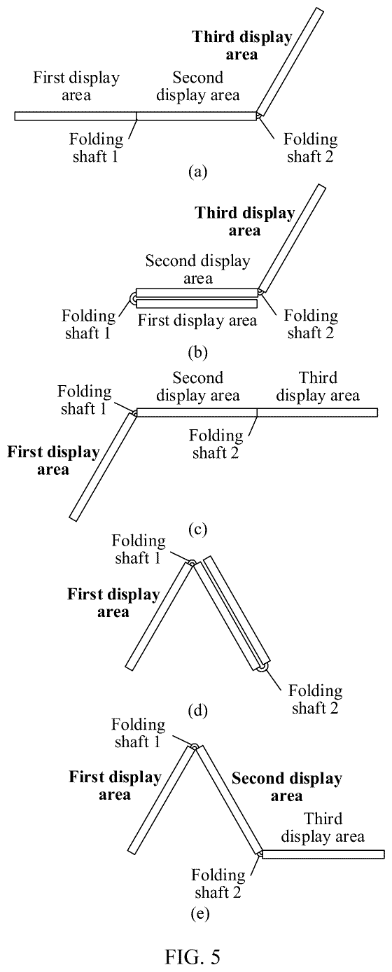

In embodiments of this application, a transition state may include a state in which two display areas connected by using a hinge are partially unfolded, and the partially-unfolded state indicates that the two display areas connected by using the hinge are not fully unfolded or folded. In one embodiment, in a process in which the electronic device is changed from a stable state to another folded state, a usage state presented by the electronic device is the transition state. For example, as shown in FIG. 5, a display of a trifold foldable screen electronic device includes three display areas. A first display area and a second display area are connected by using a hinge of a folding shaft 1, and the second display area and a third display area are connected by using a hinge of a folding shaft 2. As shown in (a) in FIG. 5, the first display area and the second display area are in a fully-unfolded state, and the second display area and the third display area are in a partially-unfolded state. In this case, the electronic device is currently in the transition state. As shown in (b) in FIG. 5, the first display area and the second display area are in a fully-folded state, and the second display area and the third display area are in a partially-unfolded state. In this case, the electronic device is currently in the transition state. As shown in (c) in FIG. 5, the first display area and the second display area are in a partially-unfolded state, and the second display area and the third display area are in a fully-unfolded state. In this case, the electronic device is currently in the transition state. As shown in (d) in FIG. 5, the first display area and the second display area are in a partially-unfolded state, and the second display area and the third display area are in a fully-folded state. In this case, the electronic device is currently in the transition state. As shown in (e) in FIG. 5, any two display areas connected by using the hinge are in a partially-unfolded state. In this case, the electronic device is currently in the transition state.

It should be understood that a connection sequence of the three display areas of the trifold foldable screen electronic device is not limited in embodiments of this application. For example, in the scenario shown in FIG. 4 or FIG. 5, the usage state of the electronic device is described by using an example in which the second display area is a middle display area between the folding shaft 1 and the folding shaft 2, and the first display area and the third display area are display areas on both sides of the second display area.

In this way, the usage state of the foldable screen electronic device is classified, so that the electronic device can subsequently determine, based on the usage state of the electronic device, a sound effect parameter that needs to be used, to implement adaptive sound effect adjustment during folding.

In some embodiments, different types of foldable screen electronic devices are preconfigured with different usage states included in the different types of foldable screen electronic devices. For example, the trifold foldable screen electronic device is preconfigured with the foregoing four stable states and five transition states.

In one embodiment, the electronic device is preconfigured with an angle threshold range, so that the electronic device may subsequently obtain a corresponding usage state based on the angle threshold range. For example, the angle threshold is 0 degrees and 180 degrees. It is determined, depending on whether an opening/closing angle between display areas is the angle threshold or whether an opening/closing angle is within a range corresponding to the angle threshold, that a state presented between the display areas is a fully-unfolded state, a fully-folded state, or a partially-unfolded state, to obtain the usage state of the electronic device.

The foregoing describes the usage state of the electronic device, and the following describes in detail a process of adjusting a sound effect based on a usage state.

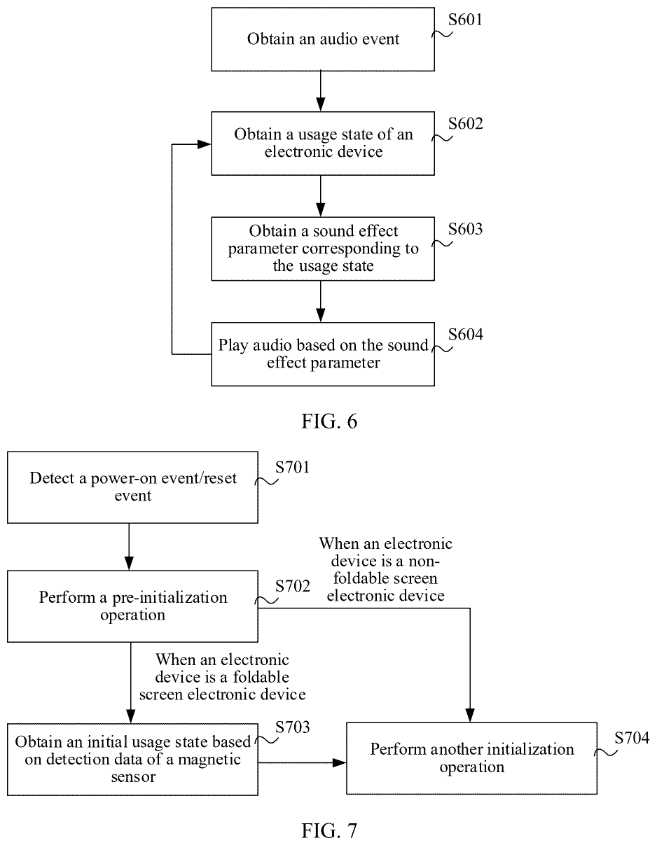

FIG. 6 is a schematic flowchart of a sound effect control method according to an embodiment of this application. It should be noted that the method is not limited to a specific sequence described in FIG. 6 and below. It should be understood that in another embodiment, a sequence of some of operations in the method may be exchanged based on an actual requirement, or some of operations in the method may be omitted or deleted. The method includes the following operations.

S601: An electronic device obtains an audio event.

The audio event is, for example, an audio playing event triggered by an application configured with an audio playing function. For example, the audio event includes music playing, audio/video playing, calling, alarms, and the like.

For example, the electronic device starts a music application when detecting an operation of a user on a music application icon. Then, in response to an operation of the user on a music playing control, the electronic device detects the audio event, and plays corresponding audio.

For another example, the electronic device determines, based on a setting operation of the user on an alarm clock application, that the user sets an alarm clock at 8:00 a.m . . . . Subsequently, the electronic device detects that time arrives at 8:00 a.m., detects the audio event, triggers the alarm clock, and plays the corresponding alarm clock based on the audio event.

S602: The electronic device obtains a usage state of the electronic device.

In some embodiments, the electronic device may detect an opening/closing angle between different display areas of a foldable screen through a sensor. Then, the electronic device determines a current usage state of the electronic device based on the opening/closing angle and a preconfigured angle threshold range.

For example, the electronic device is the trifold foldable screen electronic device shown in FIG. 4 or FIG. 5. An opening/closing angle between a first display area and a second display area is an angle 1, and an opening/closing angle between the second display area and a third display area is an angle 2. As shown in the following Table 1, the electronic device obtains the current usage state of the electronic device by identifying values of the angle 1 and the angle 2 and depending on whether the values are within a corresponding angle threshold range.

For example, as described above, a stable state includes a state in which any two display areas connected by using a hinge are fully unfolded or folded. In this case, as shown in the following Table 1, the electronic device may determine, based on a value of the angle 1 being 0° or 180°, and a value of the angle 2 being 0° or 180°, that the electronic device is currently in the stable state.

For another example, as described above, a transition state includes a state in which two display areas connected by using a hinge are partially unfolded. In this case, the electronic device shown in the following Table 1 may determine, based on either of the values of the angle 1 and the angle 2 being between 0° and 180°, that the electronic device is currently in the transition state.

TABLE 1

| Threshold range | Threshold range | | Bit |
|---|---|---|---|
| of an angle 1 | of an angle 2 | Usage state | value |
| Angle 1 = 180° | Angle 2 = 180° | Stable state | 11 |
| Angle 1 = 180° | Angle 2 = 0° | Stable state | 12 |
| Angle 1 = 180° | 0° < angle 2 < 180° | Transition state | 13 |
| Angle 1 = 0° | Angle 2 = 180° | Stable state | 21 |
| Angle 1 = 0° | Angle 2 = 0° | Stable state | 22 |
| Angle 1 = 0° | 0° < angle 2 < 180° | Transition state | 23 |
| 0° < angle 1 < 180° | Angle 2 = 180° | Transition state | 31 |
| 0° < angle 1 < 180° | Angle 2 = 0° | Transition state | 32 |
| 0° < angle 1 < 180° | 0° < angle 2 < 180° | Transition state | 33 |

In some embodiments, the electronic device sets a true value of a bit by using a bitwise operation, to indicate the usage state of the electronic device. For example, if the trifold foldable screen electronic device includes two folding shafts, a true value of a 1^{st} bit indicates an opening/closing angle, for example, the angle 1, between two display areas connected by using a hinge of a folding shaft 1, and a true value of a 0^{th} bit indicates an opening/closing angle, for example, the angle 2, between two display areas connected by using a hinge of a folding shaft 2. For example, a true value 1 indicates that the opening/closing angle is 180°, a true value 2 indicates that the opening/closing angle is 0°, and a true value 3 indicates that the opening/closing angle is between 0° and 180°. In this way, as shown in Table 1, the electronic device sets true values of different bits to indicate usage states of the electronic device. For example, the electronic device uses 11 to indicate that the opening/closing angle between the first display area and the second display area connected by the electronic device by using the hinge of the folding shaft 1 is 180°, and that the opening/closing angle between the second display area and the third display area connected by using the hinge of the folding shaft 2 is 180°, so as to indicate that the electronic device is in the stable state. In this way, the electronic device uses bit values 11, 12, 21, and 22, to indicate that the electronic device is in the stable state, and uses bit values 13, 23, 31, 32, and 33, to indicate that the electronic device is in the transition state.

It should be understood that the electronic device may alternatively use another quantity of bits and another bit true value to indicate the opening/closing angle.

In some embodiments, the electronic device may obtain, based on detection data of at least one sensor of a magnetic sensor, an acceleration sensor, and a gyroscope sensor, an opening/closing angle corresponding to a folding shaft, to obtain the usage state of the electronic device based on the opening/closing angle.

In some examples, after obtaining detection data of the acceleration sensor and the gyroscope sensor, the electronic device inputs the detection data into a preset program for processing, to output the opening/closing angle and determine the usage state of the electronic device.

In some examples, in a power-on or reset process of the electronic device, programs in the electronic device need to be initialized to complete setting of corresponding parameters, to facilitate subsequent running of the programs. There is a sequence for initialization processes of programs, and an initialization time sequence of the programs cannot be ensured. Therefore, before initialization of the preset program for determining the usage state of the electronic device is completed, the electronic device cannot detect the usage state through the acceleration sensor and the gyroscope sensor. In this case, in the power-on or reset process of the electronic device, the electronic device may determine opening/closing of the folding shaft based on detection data of the magnetic sensor, to determine the usage state of the electronic device.

In one embodiment, the magnetic sensor detects, by using a built-in magnet of each display area, whether adjacent display areas are attached, to obtain an unfolded/folded state of the folding shaft. In this way, the electronic device obtains the usage state of the electronic device based on the unfolded/folded state of the folding shaft. For example, as shown in FIG. 2B, magnetic sensors are respectively installed in three display areas of the electronic device, and may be configured to detect an unfolded/folded state of a folding shaft corresponding to an adjacent display area. In one embodiment, true values of a plurality of bits indicate unfolded/folded states of folding shafts. For example, a true value 0 indicates unfolding, and the true value 1 indicates folding. It should be understood that, the true value 1 may alternatively indicate unfolding, and a true value 0 may alternatively indicate folding.

In one embodiment, the reset process includes, for example, reset after a program of the electronic device is abnormal and crashes.

For example, FIG. 7 is a diagram of a program initialization procedure in a power-on or reset scenario according to an embodiment of this application. As shown in FIG. 7, the procedure includes the following operations.

S701: The electronic device detects a power-on event/reset event.

The power-on event includes, for example, initial power-on of the electronic device and restarting after power-off. For example, in response to a user operation, the electronic device detects the power-on event and then restarts.

The reset event includes, for example, that the electronic device triggers the reset event after detecting that a program crashes due to abnormal running, to perform reinitialization and load the program.

S702: The electronic device performs a pre-initialization operation.

Because an initialization time sequence of programs cannot be ensured, programs on which the initialization operation performed in the current operation do not include a preset program for determining a usage state. That is, the pre-initialization operation is not used to perform the initialization operation on the preset program.

S703: When the electronic device is a foldable screen electronic device, the electronic device obtains an initial usage state based on detection data of a magnetic sensor.

In some embodiments, the electronic device may obtain device information. The device information may include information such as a device type, a device model, and a device name of the electronic device. The electronic device may determine, based on the device information, whether the electronic device is the foldable screen electronic device.

In some embodiments, the electronic device learns, based on the device information, that the electronic device is the foldable screen electronic device. In addition, the electronic device may determine that the electronic device is currently in an initialization process. In this case, the electronic device may obtain the detection data of the magnetic sensor, and obtain the initial usage state of the electronic device based on the detection data, for example, determine an unfolded/folded state corresponding to each folding shaft of the current electronic device. Therefore, this avoids a problem that the usage state of the electronic device cannot be determined because initialization of the preset program is uncompleted, even if detection data of an acceleration sensor and a gyroscope sensor is obtained.

S704: When the electronic device is a non-foldable screen electronic device, the electronic device performs another initialization operation.

In some embodiments, the electronic device learns, based on the device information, that the electronic device is not the foldable screen electronic device. In this case, the electronic device may directly complete initialization processes of all programs in sequence.

In some embodiments, in a process in which (or after) the electronic device obtains the usage state of the electronic device based on the detection data of the magnetic sensor, the electronic device may perform another initialization operation, to complete an initialization process including the preset program.

In this way, the electronic device can determine the usage state of the electronic device regardless of whether initialization is completed or uncompleted, to meet a requirement for subsequently adjusting a sound effect parameter.

S603: The electronic device obtains a sound effect parameter corresponding to the usage state.

In some embodiments, after obtaining the usage state, the electronic device may obtain a corresponding sound effect parameter based on the usage state.

In one embodiment, the sound effect parameter may include, for example, a loudness parameter and a frequency parameter. A sound effect of audio played by the electronic device may be adjusted by adjusting the sound effect parameter. In one embodiment, the loudness parameter includes, for example, a loudness gain value. The frequency parameter includes, for example, a filter parameter.

In some examples, the electronic device determines, based on relative locations of different speakers in different usage states, a phase relationship between waveforms of audio played by different speakers. The electronic device may implement sound effect adjustment by adjusting relative loudness gain values of the different speakers based on the phase relationship. In this case, the electronic device may obtain loudness parameters of the speakers in different current usage states based on the phase relationship, and determine the loudness parameters as sound effect parameters.

In some examples, signals of different frequencies have different sensitivities to distance changing. In this case, the electronic device may perform filtering processing on an audio signal sent by a speaker, and selectively enhance or fade a signal of a specific frequency band, to maintain clarity and stability of the audio signal. For example, low-frequency signals (20 Hz to 200 Hz) are insensitive to distance changing, so that signal propagation and sound quality are not affected greatly, while medium- and high-frequency signals (200 Hz to 5 kHz) are more sensitive to distance changing, so that a phase difference caused by changing of the relative location of the speaker may cause poor sound quality, where for example, sound becomes blurred or a comb filtering effect is generated. In this case, the electronic device may choose to perform filtering processing on the medium- and high-frequency signals, and set corresponding filter parameters.

In some embodiments, to maintain sound effect stability of the electronic device in different usage states, the electronic device may obtain sound effect parameters corresponding to the different usage states, so that similar sound effects can be generated by audio that is subsequently output by the electronic device based on the sound effect parameters.

In some examples, because different types of products have different requirements on sound effect performance, requirements for obtaining similarities of the sound effects in the different usage states are also different. For example, the sound effect parameters corresponding to the different usage states are configured for some products, so that the electronic device can output completely same sound effects in the different usage states. For example, a sound effect deviation is 0 (or described as that a sound effect similarity is 100%). For another example, the sound effect parameters corresponding to the different usage states are configured for some products, so that a deviation of the sound effects output by the electronic device in the different usage states is less than 5% (or described as that a sound effect similarity is greater than 95%).

In one embodiment, if the deviation of the sound effects of the audio played by the electronic device in the different usage states is less than a first threshold (or described as that the sound effect similarity is greater than a second threshold), it may be determined that the sound effects are stable. The first threshold is, for example, 0%, 2%, or 5% (the second threshold is, for example, 100%, 98%, or 95%). In one embodiment, to improve use experience of the user, the first threshold is, for example, configured to be less than or equal to 5% (the second threshold is, for example, configured to be greater than or equal to 95%).

In one embodiment, the sound effect of the audio played by the electronic device is represented by, for example, a value of at least one measurement parameter: loudness, sound pressure, a frequency, phase consistency, a stereo effect, a distortion degree, and the like. In one embodiment, based on the sound effect control method provided in embodiments of this application, in a process in which the electronic device plays the audio, a value deviation of measurement parameters corresponding to the sound effects generated by the audio played in the different usage states is less than the first threshold, so that there is similar listening experience in an entire sound field in the different usage states in the process in which the electronic device plays the audio. In one embodiment, values of the measurement parameters corresponding to the sound effects generated by the audio played in the different usage states may be the same, so that the user can have same listening experience in the entire sound field in the different usage states.

In some embodiments, acoustic feature testing is performed on the electronic device in the different usage states via a test device. For example, sound wave features and sound field feature information of the audio signal played by the speaker of the electronic device in the different usage states are obtained, and difference information of the sound effects of the electronic device in the different usage states is obtained. Then, a required loudness gain value and/or a required filter parameter are obtained based on the difference information corresponding to the different usage states, so that the sound effects of the electronic device in the different usage states are the same or similar. In one embodiment, during obtaining of the loudness gain value and/or the filter parameter, a sound effect corresponding to any one of the different usage states may serve as a sound effect adjustment reference.

The sound wave feature includes, for example, an acoustic feature of an audio signal played by a single speaker, for example, one or more of sound pressure, a particle vibration displacement, a particle vibration velocity, sound impedance, sound intensity, and sound power. The sound field feature information includes, for example, information about sound field interaction between different speakers. For example, a sound field feature is measured by using parameters such as loudness and a frequency.

In one embodiment, the required loudness gain value is calculated based on the usage state, the corresponding sound wave feature and sound field feature information, and the difference information. The loudness gain value can ensure that sound field loudness output by the electronic device in the different usage states remains stable.

In one embodiment, spectrum analysis is performed on the audio signal sent by the speaker, to obtain frequency distribution of the audio signal, and a spectrum graph corresponding to the audio signal is obtained through color mapping, by using a contour graph, or in another manner. Then, the spectrum graph is analyzed based on strength of different frequency components in the audio signal, and the filter parameter is adjusted based on an analysis result, thereby achieving a selective enhancement or fading effect. In one embodiment, medium- and high-frequency signals in the audio signal are selected to be enhanced or faded.

In this way, the sound effect parameters corresponding to the different usage states can be obtained according to the foregoing method.

It should be understood that sound effect parameters corresponding to different models of foldable screen electronic devices may be different. Therefore, before the electronic device is delivered from a factory, the foregoing test process may be pre-completed, and the sound effect parameter may be configured.

In some embodiments, the electronic device may obtain a sound effect parameter of at least one of a plurality of speakers. For example, the electronic device is configured with two speakers. The electronic device adjusts loudness of either of the speakers based on a relative location relationship between the two speakers, for example, adjusts a peak value of an audio waveform corresponding to the speaker, so that a relative loudness gain of the two speakers meets a requirement. For another example, the electronic device is configured with two speakers. The electronic device adjusts a relative phase relationship between audio waveforms of the two speakers based on a relative location relationship between the two speakers, for example, shifts the audio waveforms, so that a subsequently superimposed audio waveform meets an adjustment requirement of a relative loudness gain.

In this way, after the sound effect parameter is obtained, sound effect adjustment is implemented by adjusting a sound effect parameter of a speaker, thereby ensuring that the electronic device provides similar sound effect experience for the user in the different usage states. In addition, adjusting a sound effect parameter of the single speaker is easy.

In one embodiment, the electronic device may alternatively implement sound effect adjustment by adjusting sound effect parameters of the plurality of speakers, providing better use experience for the user in more use scenarios. For example, the electronic device is placed on a fixed platform like a desktop. The electronic device may learn of, in response to changing of the usage state, one or more speakers in a display area on a side that is in contact with the fixed platform like the desktop, and implement sound effect adjustment by adjusting a sound effect parameter of the one or more speakers.

In some embodiments, the electronic device is preconfigured with sound effect parameters corresponding to different stable states. The electronic device may obtain, based on a relative location relationship between different speakers in the different stable states, a sound effect parameter for maintaining same or similar sound effects in the different stable states, and preconfigure the sound effect parameter in the electronic device. In this way, after obtaining the stable state, the electronic device can directly match a corresponding sound effect parameter, to improve sound effect parameter obtaining efficiency.

In some examples, the electronic device may also be preconfigured with a sound effect parameter corresponding to some or all of transition states.

In some other examples, the electronic device is preconfigured with the sound effect parameters corresponding to the different stable states. During subsequent use, when the electronic device is in the transition state, the electronic device may obtain, based on a sound effect parameter corresponding to a stable state adjacent to the current transition state, a sound effect parameter corresponding to the current transition state.

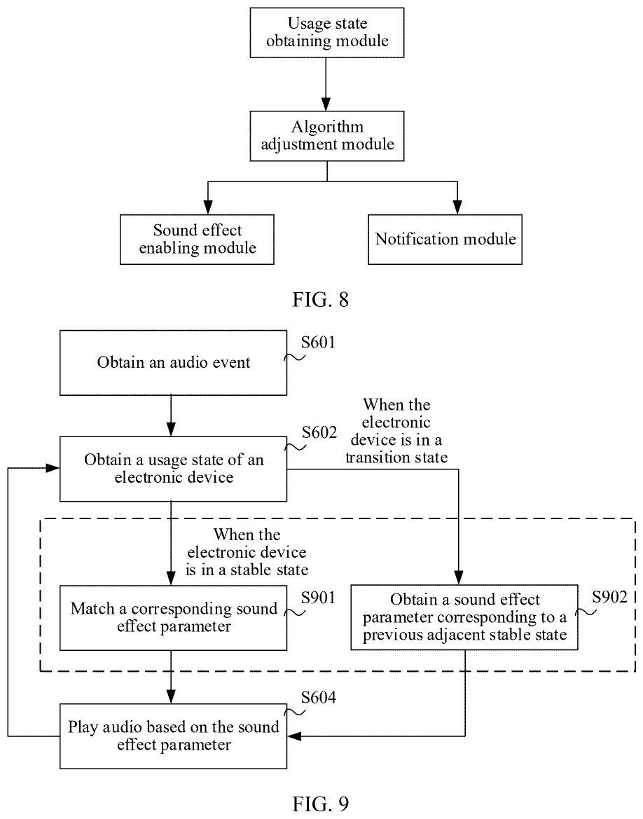

For example, as shown in FIG. 8, the electronic device includes a usage state obtaining module, an algorithm adjustment module, a sound effect enabling module, a notification module, and the like. In some examples, after obtaining the usage state of the electronic device, the usage state obtaining module may send the usage state to the algorithm adjustment module. The algorithm adjustment module may calculate the corresponding sound effect parameter based on the usage state. For example, the algorithm adjustment module obtains the sound effect parameter corresponding to the current usage state based on a preconfigured mapping relationship.

In some examples, when the current usage state is the stable state, the electronic device may match the corresponding sound effect parameter. When the current usage state is the transition state, the electronic device may choose to match a sound effect parameter corresponding to a previous adjacent stable state.

For example, as shown in FIG. 9, operation S603 may include operation S901 and operation S902, and the electronic device may obtain, through operation S901 and operation S902, a sound effect parameter corresponding to a usage state.

S901: When the electronic device is in a stable state, the electronic device matches a corresponding sound effect parameter.

In some embodiments, the electronic device is preconfigured with sound effect parameters corresponding to different stable states. In this case, the electronic device may choose, depending on whether a current usage state is the stable state, to directly match a corresponding preconfigured sound effect parameter, or to maintain a sound effect parameter corresponding to a previous adjacent stable state, to ensure sound effect stability.

In some embodiments, the current usage state of the electronic device is the stable state. In this case, the electronic device may obtain preconfigured sound effect parameters, and match a corresponding sound effect parameter based on the current stable state.

For example, as shown in Table 1, the electronic device is a trifold foldable screen electronic device, and may implement four stable states. The electronic device is preconfigured with sound effect parameters corresponding to the four stable states. In this case, the electronic device may obtain the corresponding sound effect parameter based on the current stable state. For example, the electronic device is preconfigured with a sound effect parameter A corresponding to the bit value 11, a sound effect parameter B corresponding to the bit value 12, a sound effect parameter C corresponding to the bit value 13, and a sound effect parameter D corresponding to the bit value 21. In an example scenario, the electronic device learns, through operation S602, that the current usage state of the electronic device is the stable state shown in (a) in FIG. 4, and denotes the stable state as 11. In this case, in operation S902, the electronic device matches the sound effect parameter corresponding to the current stable state as the sound effect parameter A.

It should be understood that, the electronic device learns, in response to an audio event, that the usage state is the stable state, and directly matches the sound effect parameter corresponding to the current stable state. In other words, the electronic device may not first denote a bit value corresponding to the usage state and then match the corresponding sound effect parameter based on the bit value, but directly match the corresponding sound effect parameter based on the usage state.

S902: When the electronic device is in a transition state, the electronic device obtains a sound effect parameter corresponding to a previous adjacent stable state.

In some embodiments, the electronic device learns that a current usage state is the transition state. In this case, the electronic device may obtain a previous stable state adjacent to the current transition state, obtain a sound effect parameter corresponding to the previous stable state, and use the sound effect parameter as a sound effect parameter corresponding to the current transition state. In some examples, the electronic device adaptively adjusts a sound effect parameter during folding. In this case, when the electronic device is in the transition state, a sound effect parameter obtained based on the stable state last time may be maintained, thereby maintaining basic sound effect stability.

For example, as shown in (a) in FIG. 4, the electronic device is in a fully-unfolded stable state (for example, the electronic device is in an unfolded state). In response to an operation in which a user folds a third display area inwards, before the electronic device is changed to the stable state shown in (b) in FIG. 4, the electronic device is in the transition state, and a previous stable state adjacent to the transition state is the stable state shown in (a) in FIG. 4. For example, in this process, the electronic device learns of the transition state shown in (a) in FIG. 5. In this case, the electronic device may obtain a sound effect parameter corresponding to the stable state shown in (a) in FIG. 4, and use the sound effect parameter as a current sound effect parameter corresponding to the transition state shown in (a) in FIG. 5.

In this way, regardless of any usage state, the electronic device can obtain a corresponding sound effect parameter, and implement subsequent adaptive adjustment of the sound effect based on the sound effect parameter through adaptive adjustment of the sound effect parameter.

In some other examples, when the current usage state is the stable state, the electronic device may match the corresponding sound effect parameter. When the current usage state is the transition state, the electronic device may further learn whether the electronic device is currently in a dynamic transition state or a static transition state, to obtain sound effect parameters in different transition states.

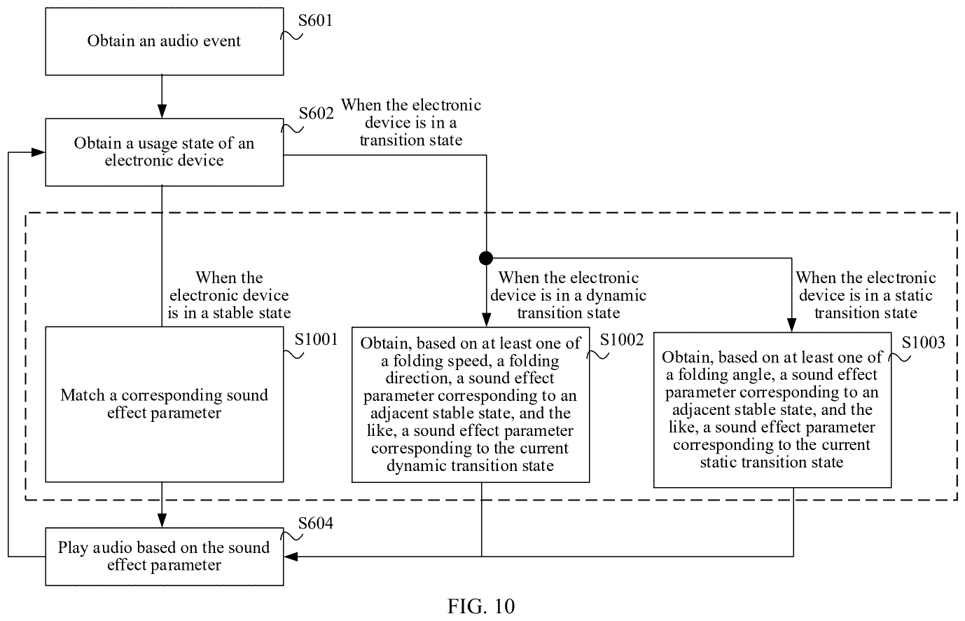

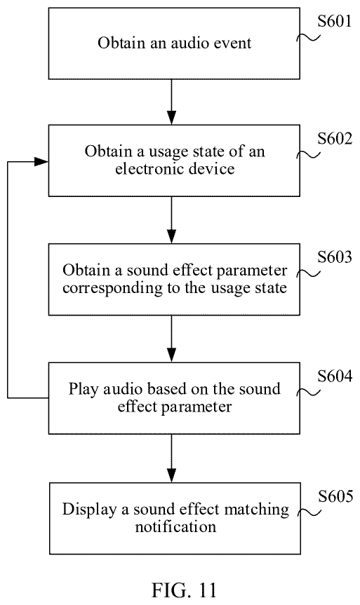

For example, as shown in FIG. 10, operation S603 may include operation S1001 to operation S1003, and the electronic device may obtain, through operation S1001 to operation S1003, a sound effect parameter corresponding to a usage state.

S1001: When the electronic device is in a stable state, the electronic device matches a corresponding sound effect parameter.

In one embodiment, for content of operation S1001, refer to the related content described in operation S901. Details are not described herein again.

S1002: When the electronic device is in a dynamic transition state in a transition state, the electronic device obtains, based on at least one of a folding speed, a folding direction, a sound effect parameter corresponding to an adjacent stable folded state, and the like, a sound effect parameter corresponding to the current dynamic transition state.

In some embodiments, the transition state includes a static transition state and a dynamic transition state. The static transition state indicates that a time period for which the electronic device maintains a transition state is greater than or equal to a time threshold (for example, one second or three seconds), and the dynamic transition state indicates that a time period for which the electronic device maintains a transition state is less than the time threshold.

For example, as shown in (a) in FIG. 4, the electronic device is in a fully-unfolded stable state (for example, the electronic device is in an unfolded state). In response to an operation in which a user folds a third display area inwards, before the electronic device is changed to the stable state shown in (b) in FIG. 4, the electronic device is in the transition state, and two stable states adjacent to the transition state are the stable state shown in (a) in FIG. 4 and the stable state shown in (b) in FIG. 4. For example, in this process, the electronic device obtains the transition state 1 shown in (a) in FIG. 5. If a time period for which the electronic device maintains the transition state 1 is less than the time threshold, and a usage state corresponding to a folding shaft 2 is changed, where for example, the third display area continues to be folded inwards, the electronic device may determine that the transition state 1 is the dynamic transition state. If a time period for which the electronic device maintains the transition state 1 is greater than or equal to the time threshold, and a usage state corresponding to a folding shaft 2 is still not changed, the electronic device may determine that the transition state 1 is the static transition state.

In some embodiments, during dynamically folding of the electronic device, a corresponding folding speed and a corresponding folding direction are generated when a corresponding display area is folded. In this case, the electronic device may obtain the folding speed and the folding direction, and use the folding speed and the folding direction as an input for calculating the sound effect parameter corresponding to the current dynamic transition state. In one embodiment, when the electronic device is in the dynamic transition state, the electronic device may further obtain two stable states adjacent to the dynamic transition state.

For example, when the transition state 1 shown in (a) in FIG. 5 is the dynamic transition state, the two stable states adjacent to the dynamic transition state are the stable state shown in (a) in FIG. 4 and the stable state shown in (b) in FIG. 4. The electronic device may obtain preconfigured sound effect parameters (for example, a sound effect parameter A and a sound effect parameter B) corresponding to the two adjacent stable states, and use the two sound effect parameters as the input for calculating the sound effect parameter corresponding to the current dynamic transition state. Then, the electronic device may obtain, through calculation based on the input, the sound effect parameter corresponding to the current dynamic transition state.

For example, the electronic device may, for example, determine, based on the stable state shown in (a) in FIG. 4, the stable state shown in (b) in FIG. 4, and the folding direction of the electronic device, that the electronic device currently switches from the stable state shown in (a) in FIG. 4 to the stable state shown in (b) in FIG. 4. In this case, the electronic device may then obtain, based on the folding speed, a switching time period required by the electronic device for switching between the two stable states. The switching time period is a sound effect transition time period between the two stable states. Then, the electronic device performs transition processing on the sound effect parameter based on the sound effect parameter A, the sound effect parameter B, and the sound effect transition time period. For example, dynamic transition of the sound effect parameter is performed through linear transition or smooth transition, or in another manner, to determine dynamic sound effect parameters corresponding to different time points.

In this way, during dynamic folding, the electronic device can implement sound effect stability by adjusting a dynamic sound effect parameter.

In some embodiments, during dynamic folding, the folding speed or the folding direction may be changed. In this case, in response to changing of the folding speed or the folding direction, the electronic device may re-determine the sound effect transition time period, and re-perform transition processing on the sound effect parameter, to obtain a new dynamic sound effect parameter.

For example, during dynamic folding, the electronic device may trigger a process of re-determining the dynamic sound effect parameter when determining that an amplitude of increasing or decreasing the folding speed exceeds a preset speed change threshold.

In this way, the sound effect is adjusted more flexibly.

S1003: When the electronic device is in the static transition state in the transition state, the electronic device determines, based on at least one of the folding angle, a sound effect parameter corresponding to an adjacent stable state, and the like, a sound effect parameter corresponding to the current static transition state.

In some embodiments, during folding, if the electronic device may maintain a transition state exceeding the time threshold, the electronic device is in the static transition state. In this case, the electronic device may obtain the folding angle corresponding to the current static transition state, and use the folding angle as an input for calculating the sound effect parameter corresponding to the current static transition state. In one embodiment, the folding angle is, for example, an opening/closing angle between two display areas corresponding to a folding shaft. In one embodiment, the electronic device determines the static transition state, and may further obtain two stable states adjacent to the static transition state.

For example, when the transition state 1 shown in (a) in FIG. 5 is the static transition state, the two stable states adjacent to the static transition state are the stable state shown in (a) in FIG. 4 and the stable state shown in (b) in FIG. 4. The electronic device may obtain preconfigured sound effect parameters corresponding to the two adjacent stable states, and use the two sound effect parameters as the input for calculating the sound effect parameter corresponding to the current static transition state. Then, the electronic device may obtain, through calculation based on the input, the sound effect parameter corresponding to the current static transition state.

In one embodiment, the electronic device obtains, based on similarities between the folding angle corresponding to the current static transition state and folding angles corresponding to the two adjacent stable states, weights of sound effect parameters corresponding to the two adjacent stable states. Then, the electronic device obtains, through weighted averaging, the sound effect parameters corresponding to the current static transition state based on the sound effect parameters corresponding to the two adjacent stable states and the weights.

For example, the electronic device is in a static transition state between the stable state A shown in (a) in FIG. 4 and the stable state B shown in (b) in FIG. 4. For example, the electronic device maintains the transition state 1 shown in (a) in FIG. 5, and a current folding angle is 135 degrees. In this case, the electronic device may learn, based on the similarity between the folding angles, that a similarity A between the transition state 1 and the stable state A is 0.75, and a similarity B between the transition state 1 and the stable state B is 0.25, determine the similarity A as a weight A of the sound effect parameter A corresponding to the stable state A, and determine the similarity B as a weight B of the sound effect parameter B corresponding to the stable state B. Then, the electronic device obtains, through weighted averaging, a sound effect parameter corresponding to the transition state 1 based on the sound effect parameter A, the weight A, the sound effect parameter B, and the weight B.

In this way, regardless of any usage state, the electronic device can obtain a corresponding sound effect parameter, and implement subsequent adaptive adjustment of the sound effect based on the sound effect parameter through adaptive adjustment of the sound effect parameter.

It should be understood that the electronic device may further configure more sound effect parameters corresponding to the usage state. In this case, the electronic device may obtain, based on the matched sound effect parameter according to the method in the foregoing example, a sound effect parameter of a usage state in which no sound effect parameter is configured and that is between adjacent usage states. For example, the electronic device is preconfigured with sound effect parameters corresponding to some static transition states. In this case, when obtaining a sound effect parameter corresponding to another transition state, the electronic device may also obtain, according to the method shown in the foregoing embodiment example, the sound effect parameter corresponding to the current transition state based on a sound effect parameter corresponding to an adjacent static transition state.

S604: The electronic device plays the audio based on the sound effect parameter.

In some embodiments, after obtaining the sound effect parameter, the electronic device may adjust a parameter of to-be-played audio of a corresponding speaker based on the sound effect parameter. After adjusting the parameter, the electronic device plays the audio through the speaker.

For example, as shown in FIG. 8, after obtaining the sound effect parameter, the algorithm adjustment module sends the sound effect parameter to the sound effect enabling module, to trigger the sound effect enabling module to play audio based on the sound effect parameter, to implement adaptive sound effect adjustment during folding.

In some embodiments, as shown in FIG. 6, operation S602 to operation S604 are cyclic operations. For example, the electronic device plays the audio in response to the audio event. During audio playing, the electronic device may adaptively adjust the sound effect parameter as the usage state changes, to implement adaptive sound effect adjustment and ensure sound effect stability.

In this way, the corresponding sound effect parameter is obtained by identifying the usage state, and the sound effect is adaptively adjusted based on the sound effect parameter, so that the electronic device can still provide stable sound effect experience for the user during changing of the usage state, to avoid an unstable sound field and improve audio playing quality.

In addition, embodiments of this application are applicable to different types of foldable screen electronic devices, such as a bifold foldable screen electronic device and a trifold foldable screen electronic device. The solutions are universal, reduce development costs, and improve development efficiency. The sound effect can be adaptively adjusted in different foldable screen electronic devices, thereby reducing errors and inconsistency.

In addition, a sound effect output affects a service life of an audio playing unit like the speaker. Therefore, proper sound effect management can effectively reduce pressure and wear on hardware, to protect the audio playing unit like the speaker from being affected by excessive stress, and prolong the service life.

In some embodiments, after the sound effect is adjusted, the electronic device may display prompt information, to prompt the user that the current sound effect has been adaptively adjusted, bringing better use experience to the user.

For example, as shown in FIG. 11, after operation S604, operation S605 is further included.

S605: The electronic device displays a sound effect matching notification.

In some embodiments, after adjusting the sound effect based on the sound effect parameter, the electronic device triggers generation of a corresponding sound effect matching notification, and displays the sound effect matching notification.

For example, as shown in FIG. 8, after the algorithm adjustment module determines the sound effect parameter, in a process in which the sound effect enabling module adjusts the sound effect, the notification module may generate the corresponding sound effect matching notification, and indicate the electronic device to display the sound effect matching notification.

In one embodiment, the electronic device may display the sound effect matching notification in any one or more of a plurality of manners such as a pop-up window, a pull-down notification bar, a top status bar notification capsule, and a lock screen notification.

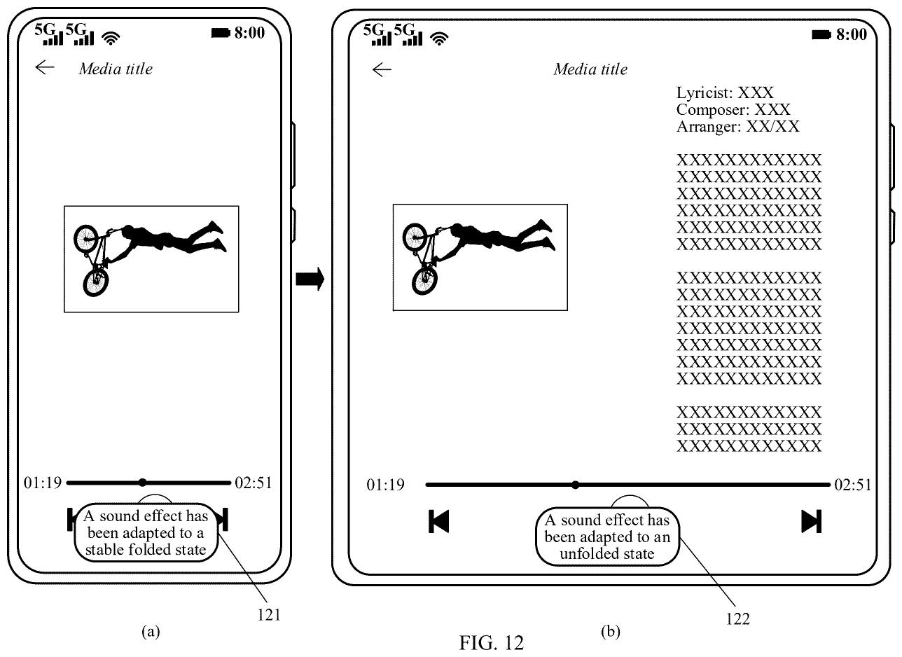

For example, as shown in (a) in FIG. 12, during audio playing, in response to a stable folded state in which the electronic device is fully folded, the electronic device matches a corresponding sound effect parameter, and adjusts a sound effect. After the sound effect is adjusted, the electronic device may display a sound effect matching notification 121, for prompting that a sound effect has been adapted to the stable folded state currently.

For another example, as shown in (b) in FIG. 12, during audio playing, in response to an unfolded state in which the electronic device is fully unfolded, the electronic device matches a corresponding sound effect parameter, and adjusts a sound effect. After the sound effect is adjusted, the electronic device may display a sound effect matching notification 122, for prompting that a sound effect has been adapted to the unfolded state currently.

In this way, during executing of an audio service, the electronic device provides synchronized visual and auditory perception for the user, to improve use experience of the user. Visually, the electronic device prompts the user with changing of the sound effect through display of an audio matching notification, and auditorily, the electronic device synchronously adjusts the sound effect based on the usage state, to provide stable sound effect experience for the user.

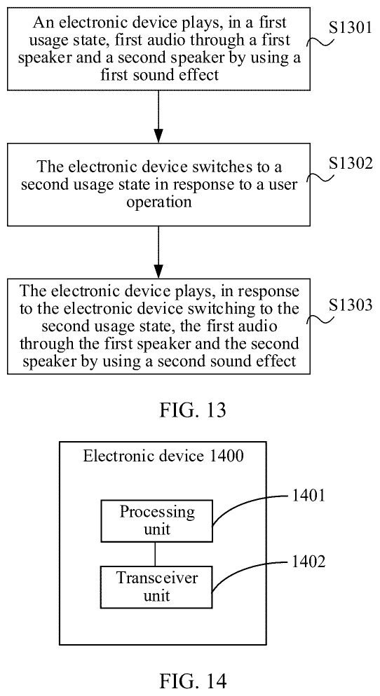

FIG. 13 is a schematic flowchart of another sound effect control method according to an embodiment of this application. It should be noted that the method is not limited to a specific sequence described in FIG. 13 and below. It should be understood that in another embodiment, a sequence of some operations in the method may be exchanged based on an actual requirement, or some operations in the method may be omitted or deleted. The method includes the following operations.

S1301: An electronic device plays, in a first usage state, first audio through a first speaker and a second speaker by using a first sound effect.

The electronic device is a foldable screen electronic device, the electronic device includes the first speaker and the second speaker, and the first speaker and the second speaker are located in different display areas of a foldable screen of the electronic device. The first usage state of the electronic device is related to a folded state of the electronic device.

In one embodiment, the electronic device may further include more than two speakers. For example, the electronic device may include three speakers. In one embodiment, when the electronic device includes more speakers, different speakers may be located in a same display area or different display areas.

In one embodiment, the first speaker performs playing by using a first sound effect parameter, and the second speaker performs playing by using a second sound effect parameter. The electronic device indicates the speaker to perform playing by using a same sound effect parameter or different sound effect parameters, so that audio played by the electronic device has the first sound effect. For example, sound fields generated by audio played by different speakers have corresponding sound effects.

In some embodiments, the electronic device obtains a usage state of the electronic device based on detection data of at least one of an acceleration sensor, a gyroscope sensor, and a magnetic sensor.

For example, the electronic device obtains the usage state of the electronic device based on detection data reported by the acceleration sensor and/or the gyroscope sensor. Alternatively, referring to the related content of the embodiment described in FIG. 7, when the electronic device is in a power-on state or a reset state, the electronic device obtains the usage state of the electronic device based on detection data reported by the magnetic sensor.

For example, the electronic device obtains a first folding angle of the electronic device in response to a first audio event. Then, the electronic device determines the first usage state of the electronic device based on the first folding angle. Then, based on the first usage state, the first speaker performs playing by using the first sound effect parameter, and the second speaker performs playing by using the second sound effect parameter.

In one embodiment, the electronic device triggers, in response to the first audio event, obtaining of the usage state of the electronic device. Alternatively, the electronic device triggers, in response to an operation in which a user changes the usage state, obtaining of the usage state of the electronic device. The operation of changing the usage state includes, for example, an operation of folding or unfolding the foldable screen of the electronic device.

In one embodiment, the electronic device obtains the first folding angle by obtaining detection data reported by a sensor.

In this way, the electronic device can obtain the usage state of the electronic device based on the folding angle, to indicate the speaker to play audio by using a corresponding sound effect parameter.

In some embodiments, the first usage state is a first stable state. In this case, the electronic device matches, in a plurality of preconfigured sound effect parameters, the first sound effect parameter corresponding to the first stable state. Then, the first speaker performs playing by using the first sound effect parameter.

In some embodiments, the first usage state is a first transition state. In this case, the electronic device matches, in the plurality of preconfigured sound effect parameters, the first sound effect parameter corresponding to a second stable state, where the second stable state is a previous stable state adjacent to the first transition state. Then, the first speaker performs playing by using the first sound effect parameter.

For example, as described in operation S901 or operation S902, the electronic device may be preconfigured with sound effect parameters corresponding to different stable states of the electronic device, and usage parameters corresponding to different usage states may be obtained based on the sound effect parameters corresponding to the stable states. For example, the electronic device is in the stable state shown in (a) in FIG. 4, and a sound effect parameter corresponding to the current stable state may be matched in the plurality of preconfigured sound effect parameters. Alternatively, the electronic device is in the transition state shown in (a) in FIG. 5, and may obtain a previous stable state adjacent to the transition state, for example, the stable state shown in (a) in FIG. 4. In this case, the electronic device may obtain the sound effect parameter corresponding to the stable state shown in (a) in FIG. 4, and use the sound effect parameter as a sound effect parameter used in the current transition state.

In this way, when being in a stable state, the electronic device can directly match a corresponding sound effect parameter. In addition, when being in a transition state, the electronic device may still maintain a sound effect parameter used in a previous stable state for subsequent use. In this way, regardless of any usage state, the electronic device can obtain a corresponding sound effect parameter, and implement subsequent adaptive adjustment of a sound effect based on the sound effect parameter through adaptive adjustment of the sound effect parameter.

In some embodiments, the first usage state is a first static transition state. In this case, the electronic device matches, in the plurality of preconfigured sound effect parameters, a fifth sound effect parameter corresponding to a third stable state and a sixth sound effect parameter corresponding to a fourth stable state, where the third stable state and the fourth stable state are stable states adjacent to the first static transition state. Then, the electronic device obtains the first sound effect parameter based on at least one of a second folding angle of the electronic device, the fifth sound effect parameter, and the sixth sound effect parameter. Then, the first speaker performs playing by using the first sound effect parameter.

In some embodiments, the first usage state is a first dynamic transition state. In this case, the electronic device matches, in the plurality of preconfigured sound effect parameters, a seventh sound effect parameter corresponding to a fifth stable state and an eighth sound effect parameter corresponding to a sixth stable state, where the fifth stable state and the sixth stable state are stable states adjacent to the first dynamic transition state. Then, the electronic device obtains the first sound effect parameter based on at least one of a folding speed of the electronic device, a folding direction of the electronic device, the seventh sound effect parameter, and the eighth sound effect parameter. Then, the first speaker performs playing by using the first sound effect parameter.

For example, as described in operation S1002 or operation S1003, the electronic device may be preconfigured with sound effect parameters corresponding to different stable states of the electronic device, and usage parameters corresponding to different usage states may be obtained based on the sound effect parameters corresponding to the stable states. For example, the electronic device is in the static transition state shown in (a) in FIG. 5, and may obtain two stable states adjacent to the static transition state. For example, the two stable states adjacent to the static transition state are the stable state shown in (a) in FIG. 4 and the stable state shown in (b) in FIG. 4. In this case, the electronic device may obtain, based on sound effect parameters corresponding to the two adjacent stable states and a current folding angle, a sound effect parameter corresponding to the current stable transition state. Alternatively, the electronic device is in the dynamic transition state shown in (a) in FIG. 5, and may obtain two stable states adjacent to the dynamic transition state. For example, the two stable states adjacent to the dynamic transition state are the stable state shown in (a) in FIG. 4 and the stable state shown in (b) in FIG. 4. In this case, the electronic device may obtain, based on sound effect parameters corresponding to the two adjacent stable states, a current folding direction, and a folding speed, a sound effect parameter corresponding to the current dynamic transition state.

In this way, when being in a stable state, the electronic device can directly match a corresponding sound effect parameter. In addition, when the electronic device is in a transition state, the electronic device may further obtain, based on a sound effect parameter corresponding to an adjacent stable state, a sound effect parameter corresponding to the current transition state. In this way, regardless of any usage state, the electronic device can obtain the corresponding sound effect parameter, and implement subsequent adaptive adjustment of the sound effect based on the sound effect parameter through adaptive adjustment of the sound effect parameter.

S1302: The electronic device switches to a second usage state in response to a user operation.

The second usage state of the electronic device is related to the folded state of the electronic device.

In one embodiment, the user operation is, for example, the operation of folding or unfolding the foldable screen of the electronic device.

S1303: The electronic device plays, in response to the electronic device switching to the second usage state, the first audio through the first speaker and the second speaker by using the second sound effect.

The first speaker performs playing by using a third sound effect parameter, and the second speaker performs playing by using a fourth sound effect parameter. The first sound effect parameter is different from the third sound effect parameter, a deviation between the second sound effect and the first sound effect is less than a first threshold, and the first usage state and the second usage state are related to the folded state of the electronic device.

In this way, the electronic device can adjust a sound effect parameter of one of a plurality of speakers in response to switching of the usage state, so that sound fields generated by audio played by the plurality of speakers can achieve similar sound effects in different usage states, to meet a sound effect stability requirement and improve use experience of the user.

In some embodiments, the second sound effect parameter is the same as the fourth sound effect parameter.

In this way, adaptive sound effect adjustment is implemented by adjusting a sound effect parameter of a single speaker. Adjusting the single sound effect parameter is easy, reducing difficulty in adjusting the sound effect.

In some embodiments, the second sound effect parameter is different from the fourth sound effect parameter.

In this way, adaptive sound effect adjustment is implemented by adjusting sound effect parameters of the plurality of speakers, providing better use experience for the user in more use scenarios. For example, the electronic device is placed on a fixed platform like a desktop. The electronic device may learn of, in response to changing of the usage state, one or more speakers in a display area on a side that is in contact with the fixed platform like the desktop, and implement sound effect adjustment by adjusting a sound effect parameter of the one or more speakers.

In some embodiments, the first sound effect or the second sound effect is represented by a value of at least one of the following measurement parameters: loudness, sound pressure, a frequency, phase consistency, a stereo effect, and a distortion degree. In one embodiment, that the deviation between the second sound effect and the first sound effect is less than the first threshold includes: a deviation between a first value of a measurement parameter corresponding to the first sound effect and a second value of a measurement parameter corresponding to the second sound effect is less than the first threshold.

In one embodiment, acoustic feature testing is performed on the electronic device in the different usage states via a test device, and values of measurement parameters corresponding to sound effects generated by audio played by the electronic device in the different usage states may be obtained.

In this way, the electronic device is debugged by measuring, by using a plurality of measurement parameters, whether sound effects provided by the electronic device in the different usage states are similar. In this way, before the user actually uses the electronic device, the electronic device can be preconfigured with the sound effect parameters corresponding to the different usage states.

In some embodiments, in a dynamic change process of folding the foldable screen of the electronic device, the first sound effect parameter is dynamically changed to the second sound effect parameter.

For example, as shown in (a) in FIG. 4, the electronic device is in a stable state 1, and indicates the speaker to perform playing by using a sound effect parameter 1. The electronic device is folded from the current stable state 1 to a stable state 2 shown in (b) in FIG. 4 in response to an operation in which the user folds the display. During folding, the electronic device dynamically adjusts the sound effect parameter based on parameters such as the folding direction and the folding speed, or based on parameters like the folding angle, and indicates the speaker to perform playing by using a corresponding sound effect parameter. Then, after changing to the stable state 2, the electronic device indicates the speaker to perform playing by using a sound effect parameter 2 corresponding to the stable state 2.

In this way, during changing of the usage state of the electronic device, the electronic device provides similar sound effect experience for the user as a sound effect parameter smoothly changes.

In some embodiments, after the electronic device plays, in response to the electronic device switching to the second usage state, the first audio through the first speaker and the second speaker by using the second sound effect, the electronic device displays a sound effect matching notification, where the sound effect matching notification indicates that the electronic device has currently matched a sound effect corresponding to the second usage state.

In this way, refer to the content shown in operation S605. The electronic device may provide synchronized visual and auditory perception for the user in response to changing of the usage state, to improve use experience of the user.

In some solutions, a plurality of embodiments of this application may be combined, and a combined solution is implemented. In one embodiment, some operations in procedures of the foregoing method embodiments are randomly combined, and/or a sequence of some operations is randomly changed. In addition, an execution sequence between operations of each procedure is merely an example, and does not constitute any limitation on the execution sequence between the operations. The operations may alternatively be performed in another execution sequence. It is not intended to indicate that the execution sequence is the only sequence in which these operations can be performed. A person of ordinary skill in the art may figure out a plurality of manners to reorder the operations described in this specification. In addition, it should be noted that process details related to a specific embodiment in this specification are also applicable to another embodiment in a similar manner, or different embodiments may be used in combination.

In addition, some operations in the method embodiments may be equivalently replaced with other possible operations. Alternatively, some operations in the method embodiments may be optional, and may be deleted in some use scenarios. Alternatively, another possible operation may be added to the method embodiments.

In addition, the method embodiments may be implemented separately or in combination.

The foregoing describes in detail the sound effect control methods provided in embodiments of this application with reference to FIG. 4 to FIG. 13. The following describes in detail an electronic device provided in embodiments of this application with reference to FIG. 14.

In a possible design, FIG. 14 is a diagram of a structure of an electronic device according to an embodiment of this application. As shown in FIG. 14, the electronic device 1400 may include a processing unit 1401 and a transceiver unit 1402. The electronic device 1400 may be configured to implement functions of the electronic device in the foregoing method embodiments.

In one embodiment, the processing unit 1401 is configured to support the electronic device 1400 in performing S601, S602, and S603 in FIG. 6; is configured to support the electronic device 1400 in performing S702, S703, and S704 in FIG. 7; is configured to support the electronic device 1400 in performing S901 and S902 in FIG. 9; is configured to support the electronic device 1400 in performing S1001, S1002, and S1003 in FIG. 10; and/or is configured to support the electronic device 1400 in performing S1302 in FIG. 13.

In one embodiment, the transceiver unit 1402 is configured to support the electronic device 1400 in performing S604 in FIG. 6; is configured to support the electronic device 1400 in performing S701 in FIG. 7; and/or is configured to support the electronic device 1400 in performing S1301 and S1303 in FIG. 13.

The transceiver unit may include a receiving unit and a sending unit, may be implemented by a transceiver or a transceiver-related circuit component, and may be a transceiver or a transceiver module. Operations and/or functions of the units in the electronic device 1400 are separately used to implement corresponding procedures of the sound effect control methods in the foregoing method embodiments. All related content of the operations in the foregoing method embodiments may be cited in function descriptions of corresponding functional units. For brevity, details are not described herein.

In one embodiment, the electronic device 1400 shown in FIG. 14 may further include a display unit (not shown in FIG. 14). The display unit is configured to support the electronic device 1400 in performing S605 in FIG. 11.

In one embodiment, the electronic device 1400 shown in FIG. 14 may further include a storage unit (not shown in FIG. 14). The storage unit stores a program or instructions. When the processing unit 1401 and the transceiver unit 1402 execute the program or the instructions, the electronic device 1400 shown in FIG. 14 is caused to perform the sound effect control methods in the foregoing method embodiments.

For technical effects of the electronic device 1400 shown in FIG. 14, refer to the technical effects of the sound effect control methods in the foregoing method embodiments. Details are not described herein again.

In addition to a form of the electronic device 1400, the technical solutions provided in this application may also be a functional unit or a chip in the electronic device, or an apparatus used together with the electronic device.

An embodiment of this application further provides a chip system, including a processor, the processor is coupled to a memory, and the memory is configured to store a program or instructions. When the program or the instructions are executed by the processor, the chip system is caused to implement the method according to any one of the foregoing method embodiments.

In one embodiment, there may be one or more processors in the chip system. The processor may be implemented by using hardware, or may be implemented by using software. When the processor is implemented by using the hardware, the processor may be a logic circuit, an integrated circuit, or the like. When the processor is implemented by using the software, the processor may be a general-purpose processor, and is implemented by reading software code stored in the memory.

In one embodiment, there may also be one or more memories in the chip system. The memory may be integrated with the processor, or may be disposed separately from the processor. This is not limited in embodiments of this application. For example, the memory may be a non-transitory processor, for example, a read-only memory ROM. The memory and the processor may be integrated into a same chip, or may be separately disposed on different chips. A type of the memory and a manner of disposing the memory and the processor are not specifically limited in embodiments of this application.

For example, the chip system may be a field programmable gate array (FPGA), an application-specific integrated circuit (ASIC), a system on chip (SoC), a central processing unit (CPU), a network processor (NP), a digital signal processor (DSP), a microcontroller unit (MCU), a programmable logic device (PLD), or another integrated chip.

It should be understood that the operations in the foregoing method embodiments may be completed by using an integrated logic circuit of hardware in the processor or instructions in a form of software. The operations of the methods disclosed with reference to embodiments of this application may be directly performed and completed by a hardware processor, or may be performed and completed by using a combination of hardware and a software module in the processor.

An embodiment of this application further provides a computer-readable storage medium. The computer-readable storage medium stores a computer program. When the computer program runs on a computer, the computer is caused to perform the foregoing related operations, to implement the sound effect control methods in the foregoing embodiments.

An embodiment of this application further provides a computer program product. When the computer program product runs on a computer, the computer is caused to perform the foregoing related operations, to implement the sound effect control methods in the foregoing embodiments.

In addition, an embodiment of this application further provides an apparatus. The apparatus may be specifically a component or a module, and the apparatus may include one or more processors and memories that are connected to each other. The memory is configured to store a computer program. When the computer program is executed by the one or more processors, the apparatus is caused to perform the sound effect control methods in the foregoing method embodiments.

The apparatus, the computer-readable storage medium, the computer program product, or the chip provided in embodiments of this application is configured to perform the corresponding method provided above. Therefore, for beneficial effects that can be achieved, refer to the beneficial effects in the corresponding method provided above. Details are not described herein again.

Methods or algorithm operations described in combination with the content disclosed in this embodiment of this application may be implemented by hardware, or may be implemented by a processor by executing a software instruction. The software instructions may include a corresponding software module. The software module may be stored in a random access memory (RAM), a flash memory, a read-only memory (ROM), an erasable programmable read-only memory (EPROM), an electrically erasable programmable read-only memory (EEPROM), a register, a hard disk drive, a removable hard disk drive, a compact disc read-only memory (CD-ROM), or any other form of storage medium well-known in the art. In an example, a storage medium is coupled to a processor, so that the processor can read information from the storage medium and write information into the storage medium. Certainly, the storage medium may be a component of the processor. The processor and the storage medium may be located in an application-specific integrated circuit (ASIC).

The descriptions of the foregoing implementations allows a person skilled in the art to clearly understand that, for convenient and brief description, division of the foregoing functional modules is used as merely an example for description. During actual application, the foregoing functions can be allocated to different functional modules for completion as required. That is, an internal structure of the apparatus is divided into different functional modules to complete all or some of the functions described above. For a specific operating process of the foregoing system, apparatus, and unit, refer to a corresponding process in the foregoing method embodiments. Details are not described herein again.

In the several embodiments provided in this application, it should be understood that the disclosed methods may be implemented in other manners. The apparatus embodiments described above are merely examples. For example, division into the modules or units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the modules or units may be implemented in electrical, mechanical, or other forms.

In addition, all functional units in embodiments of this application may be integrated into one processing unit, or each of the units may exist alone physically, or two or more units are integrated into one unit. The integrated unit may be implemented in a form of hardware, or may be implemented in a form of a software functional unit.

The computer-readable storage medium includes but is not limited to any one of the following: any medium that can store program code, such as a USB flash drive, a removable hard disk drive, a read-only memory (ROM), a random access memory (RAM), a magnetic disk, or an optical disc.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

What is claimed is:

1. A method of sound effect control, applied to an electronic device, comprising:
playing, by the electronic device in a first usage state, first audio through a first speaker and a second speaker by using a first sound effect, wherein the first speaker performs playing by using a first sound effect parameter, and the second speaker performs playing by using a second sound effect parameter, wherein the electronic device is a foldable screen electronic device, the electronic device comprises the first speaker and the second speaker, and the first speaker and the second speaker are located in different display areas of a foldable screen of the electronic device;
switching, by the electronic device, to a second usage state in response to a user operation; and
playing, by the electronic device in response to the electronic device switching to the second usage state, the first audio through the first speaker and the second speaker by using a second sound effect, wherein the first speaker performs playing by using a third sound effect parameter, the second speaker performs playing by using a fourth sound effect parameter, the first sound effect parameter is different from the third sound effect parameter, a deviation between the second sound effect and the first sound effect is less than a first threshold, and the first usage state and the second usage state are related to a folded state of the electronic device.

2. The method according to claim 1, wherein the electronic device is a trifold foldable screen electronic device, a first display area and a second display area of the foldable screen of the electronic device are connected by using a first folding shaft, the second display area and a third display area of the foldable screen of the electronic device are connected by using a second folding shaft, the first speaker is located in the first display area, and the second speaker is located in the third display area.

3. The method according to claim 2, wherein the first speaker is located in an upper left corner of the first display area, and the second speaker is located in a lower right corner of the third display area; or the first speaker is located in a lower left corner of the first display area, and the second speaker is located in an upper right corner of the third display area.

4. The method according to claim 1, wherein the first sound effect or the second sound effect is represented by a value of at least one of following measurement parameters: loudness, sound pressure, a frequency, phase consistency, a stereo effect, or a distortion degree.

5. The method according to claim 4, wherein that the deviation between the second sound effect and the first sound effect is less than the first threshold comprises: a deviation between a first value of a measurement parameter corresponding to the first sound effect and a second value of a measurement parameter corresponding to the second sound effect is less than the first threshold.

6. The method according to claim 1, wherein playing, by the electronic device, the first audio through the first speaker and the second speaker by using the first sound effect comprises:
obtaining a first folding angle of the electronic device in response to a first audio event;
determining the first usage state of the electronic device based on the first folding angle; and
based on the first usage state, performing, by the first speaker, playing by using the first sound effect parameter, and performing, by the second speaker, playing by using the second sound effect parameter.

7. The method according to claim 1, wherein the second sound effect parameter is same as the fourth sound effect parameter.

8. The method according to claim 1, wherein the second sound effect parameter is different from the fourth sound effect parameter.

9. The method according to claim 1, wherein the first usage state is a first stable state; and playing, by the electronic device in the first usage state, the first audio through the first speaker and the second speaker by using the first sound effect comprises:
matching, by the electronic device in a plurality of preconfigured sound effect parameters, the first sound effect parameter corresponding to the first stable state; and
performing, by the first speaker, playing by using the first sound effect parameter.

10. The method according to claim 1, wherein the first usage state is a first transition state; and playing, by the electronic device in the first usage state, the first audio through the first speaker and the second speaker by using the first sound effect comprises:
matching, by the electronic device in a plurality of preconfigured sound effect parameters, the first sound effect parameter corresponding to a second stable state, wherein the second stable state is a previous stable state adjacent to the first transition state; and
performing, by the first speaker, playing by using the first sound effect parameter.

11. The method according to claim 1, wherein the first usage state is a first static transition state; and playing, by the electronic device in the first usage state, the first audio through the first speaker and the second speaker by using the first sound effect comprises:
matching, by the electronic device in a plurality of preconfigured sound effect parameters, a fifth sound effect parameter corresponding to a third stable state and a sixth sound effect parameter corresponding to a fourth stable state, wherein the third stable state and the fourth stable state are stable states adjacent to the first static transition state;
obtaining, by the electronic device, the first sound effect parameter based on at least one of a second folding angle of the electronic device, the fifth sound effect parameter, and the sixth sound effect parameter; and
performing, by the first speaker, playing by using the first sound effect parameter.

12. The method according to claim 1, wherein the first usage state is a first dynamic transition state; and playing, by the electronic device in the first usage state, the first audio through the first speaker and the second speaker by using the first sound effect comprises:
matching, by the electronic device in a plurality of preconfigured sound effect parameters, a seventh sound effect parameter corresponding to a fifth stable state and an eighth sound effect parameter corresponding to a sixth stable state, wherein the fifth stable state and the sixth stable state are stable states adjacent to the first dynamic transition state;
obtaining, by the electronic device, the first sound effect parameter based on at least one of a folding speed of the electronic device, a folding direction of the electronic device, the seventh sound effect parameter, or the eighth sound effect parameter; and
performing, by the first speaker, playing by using the first sound effect parameter.

13. The method according to claim 1, wherein, in a dynamic change process of folding the foldable screen of the electronic device, the first sound effect parameter is dynamically changed to the second sound effect parameter.

14. The method according to claim 1, wherein after the playing, by the electronic device in response to the electronic device switching to the second usage state, the first audio through the first speaker and the second speaker by using the second sound effect, the method further comprises:
displaying, by the electronic device, a sound effect matching notification, wherein the sound effect matching notification indicates that the electronic device has currently matched a sound effect corresponding to the second usage state.

15. The method according to claim 1, wherein the first usage state comprises a stable state and a transition state, the stable state comprises an unfolded state and a stable folded state, the unfolded state comprises a state in which any two connected display areas of the foldable screen of the electronic device are fully unfolded, the stable folded state comprises a state in which any two connected display areas of the foldable screen of the electronic device are fully unfolded or folded, and the transition state comprises a state in which two connected display areas of the foldable screen of the electronic device are partially unfolded.

16. The method according to claim 15, wherein the transition state comprises a static transition state and a dynamic transition state, the static transition state indicates that duration in which the electronic device maintains the transition state is greater than or equal to a time threshold, and the dynamic transition state indicates that duration in which the electronic device maintains the transition state is less than the time threshold.

17. The method according to claim 1, wherein the switching, by the electronic device, to the second usage state in response to the user operation comprises:
obtaining, by the electronic device in response to the user operation, first detection data reported by an acceleration sensor and/or a gyroscope sensor; and
obtaining, by the electronic device, the second usage state of the electronic device based on the first detection data.

18. The method according to claim 1, wherein the switching, by the electronic device, to the second usage state in response to the user operation comprises:
learning, by the electronic device in response to the user operation, that the electronic device is in a power-on state or a reset state;
obtaining, by the electronic device, second detection data reported by a magnetic sensor; and
obtaining, by the electronic device, the second usage state of the electronic device based on the second detection data.

19. An electronic device, comprising:
a processor,
a memory,
a first speaker, and
a second speaker, wherein the memory, the first speaker, and the second speaker are coupled to the processor, the memory is configured to store computer program code comprising computer instructions, which when executed by the processor, cause the electronic device to:
play first audio through the first speaker and the second speaker by using a first sound effect, wherein the first speaker plays by using a first sound effect parameter, and the second speaker plays by using a second sound effect parameter, wherein the electronic device is a foldable screen electronic device, and the first speaker and the second speaker are located in different display areas of a foldable screen of the electronic device;
switch to a second usage state in response to a user operation; and
play, in response to the electronic device switching to the second usage state, the first audio through the first speaker and the second speaker by using a second sound effect, wherein the first speaker plays by using a third sound effect parameter, the second speaker plays by using a fourth sound effect parameter, the first sound effect parameter is different from the third sound effect parameter, a deviation between the second sound effect and the first sound effect is less than a first threshold, and the first usage state and the second usage state are related to a folded state of the electronic device.

20. A non-transitory machine-readable medium having instructions stored therein, which when executed by a processor, cause the electronic device to:
play first audio through a first speaker and a second speaker by using a first sound effect, wherein the first speaker plays by using a first sound effect parameter, and the second speaker plays by using a second sound effect parameter, wherein the electronic device is a foldable screen electronic device, the electronic device comprises the first speaker and the second speaker, and the first speaker and the second speaker are located in different display areas of a foldable screen of the electronic device;
switch to a second usage state in response to a user operation; and
play, in response to the electronic device switching to the second usage state, the first audio through the first speaker and the second speaker by using a second sound effect, wherein the first speaker plays by using a third sound effect parameter, the second speaker plays by using a fourth sound effect parameter, the first sound effect parameter is different from the third sound effect parameter, a deviation between the second sound effect and the first sound effect is less than a first threshold, and the first usage state and the second usage state are related to a folded state of the electronic device.
